(19) United States
(12) Patent Application Publication
(10) Pub. No.: US 2026/0107034 A1
(43) Pub. Date: Apr. 16, 2026

(54) Apparatus and Method for Coding, Transport and Signaling of Logos and Icons in Television and Radio Broadcasts

(71) Applicant: Fraunhofer-Gesellschaft zur Förderung der angewandten Forschung e.V., Muenchen (DE)

(72) Inventors: Alexander ZINK, Erlangen (DE); Markus PROSCH, Erlangen (DE); Guido LEISKER, Erlangen (DE); Stefan MELTZER, Erlangen (DE); André HIRSCH, Erlangen (DE); Markus TAUBER, Erlangen (DE); Thimmaiah KUPPANDA GANAPATHY, Erlangen (DE); S. Merrill WEISS, Edison, NJ (US)

(73) Assignee: Fraunhofer-Gesellschaft zur Förderung der angewandten Forschung e.V., Muenchen (DE)

(21) Appl. No.: 19/243,747

(22) Filed: Jun. 20, 2025

Related U.S. Application Data
(63) Continuation of application No. PCT/EP2023/085524, filed on Dec. 13, 2023.

(30) Foreign Application Priority Data
Dec. 20, 2022 (WO) PCT/EP2022/087104

(51) Int. Cl. H04N 21/431; H04N 19/169; H04N 19/70; H04N 21/47; H04N 21/81

(52) U.S. Cl. CPC H04N 21/4312; H04N 19/188; H04N 19/70; H04N 21/47; H04N 21/8146

(57) ABSTRACT

FIG. 1 illustrates an apparatus for decoding according to an embodiment. The apparatus includes an interface for receiving a plurality of ATSC Link-layer Protocol packets each of which including a packet header and a packet payload, wherein the packet payload of an ATSC Link-layer Protocol packet of the plurality of ATSC Link-layer Protocol packets includes image data of one or more logos and/or of one or more icons. Moreover, the apparatus includes a decoding unit for decoding the packet payload of said ATSC Link-layer Protocol packet to obtain the image data.

### CROSS-REFERENCES TO RELATED APPLICATIONS

This application is a continuation of copending International Application No. PCT/EP2023/085524, filed Dec. 13, 2023, which is incorporated herein by reference in its entirety, and additionally claims priority from International Application No. PCT/EP2022/087104, filed Dec. 20, 2022, which is incorporated herein by reference in its entirety.

The present invention relates to coding, transport and signaling of logos and icons in television and radio broadcasts, in particular, to apparatuses and methods for coding of logos and icons in television broadcasts, more particularly, for digital television and digital radio DRM in ATSC television broadcasts.

### BACKGROUND OF THE INVENTION

The ATSC standards are a group of standards provided by the Advanced Television Systems Committee (ATSC) for digital television transmissions. Details on the Data Link Layer Protocol employed by ATSC can be found in the respective standard, [1]: A/330:2022-03, “Link-Layer Protocol”, published 31 Mar. 2022. ALP (ATSC Link-layer Protocol) supports the encapsulation of IP packets.

Digital Radio Mondiale (DRM) is a globally deployed radio broadcasting standard. It delivers full-featured digital radio services in a highly efficiently coded manner, together with advanced text and other data services, to make best use of available channel resources. In parts of the world where DRM is in use, it is highly desirable for a broadcaster to be able to create and transmit identical Multiplex Distribution Interface (MDI) streams both on radio broadcasting spectrum and on television spectrum that will be able to reach mobile and handheld devices efficiently, ensuring a consistent digital radio experience for consumers.

DRM allows to transmit multimedia data with particularly low data rates by employing the technologies xHE-AAC (extended High Efficiency Advanced Audio Coding)/USAC (Unified Speech and Audio Coding) and Journaline.

A particular technology employed by DRM is the Distribution and Communications Protocol (DCP) described in [3]: ETSI: TS 102 821, “Digital Radio Mondiale (DRM); Distribution and Communications Protocol (DCP),” V1.4.1 (2012-10), European Telecommunications Standards Institute, Valbonne—Sophia Antipolis France, October 2012.

DRM allows to transmit program logos in transmission signals. However, the DRM specification is designed for radio receivers with a relatively small display, and is therefore not flexible enough for usage with ATSC. It is thus not reasonable, to transmit logos for TV programs in DRM radio program transmissions.

Until now, ATSC 3.0 does not provide means to transmit logos in the transmission signal. Logos and icons, however, are important factors for user experience, e.g., when it comes to program selection, application-specific user interface design, etc., but also for the program provide, e.g., with respect to promoting trademarks and brands.

As ATSC 3.0 is attracting greater attention for potential adoption in more countries, it would be highly appreciated that ATSC provides full-featured support for the transmission of logos and icons in broadcast transmissions.

### SUMMARY

An embodiment may have an apparatus for decoding, comprising: an interface for receiving a plurality of ATSC Link-layer Protocol packets each of which comprising a packet header and a packet payload, wherein the packet payload of an ATSC Link-layer Protocol packet of the plurality of ATSC Link-layer Protocol packets comprises image data of one or more logos and/or of one or more icons, and a decoding unit for decoding the packet payload of said ATSC Link-layer Protocol packet to acquire the image data.

Another embodiment may have an apparatus for generating a plurality of ATSC Link-layer Protocol packets, wherein the apparatus comprises: an interface for receiving image data of one or more logos and/or of one or more icons, and a packet generator for generating the plurality of ATSC Link-layer Protocol packets, such that each of the plurality of ATSC Link-layer Protocol packets comprises a packet header and a packet payload, wherein the packet generator is configured to generate an ATSC Link-layer Protocol packet of the plurality of ATSC Link-layer Protocol packets, such that the packet payload of said ATSC Link-layer Protocol comprises the image data.

Another embodiment may have a data stream comprising a plurality of ATSC Link-layer Protocol packets, wherein each of the plurality of ATSC Link-layer Protocol packets comprises a packet header and a packet payload, wherein the packet payload of each of the plurality of ATSC Link-layer Protocol packets comprises image data of one or more logos and/or of one or more icons.

Another embodiment may have a system, comprising: an apparatus according to the invention for generating a plurality of ATSC Link-layer Protocol packets, and an apparatus according to the invention for decoding, wherein the apparatus for decoding is configured to receive and decode the plurality of ATSC Link-layer Protocol packets.

Another embodiment may have a method for decoding, comprising: receiving a plurality of ATSC Link-layer Protocol packets each of which comprising a packet header and a packet payload, wherein the packet payload of an ATSC Link-layer Protocol packet of the plurality of ATSC Link-layer Protocol packets comprises image data of one or more logos and/or of one or more icons, and decoding the packet payload of said ATSC Link-layer Protocol packet to acquire the image data.

Another embodiment may have a method for generating a plurality of ATSC Link-layer Protocol packets, wherein the method comprises: receiving image data of one or more logos and/or of one or more icons, and generating the plurality of ATSC Link-layer Protocol packets, such that each of the plurality of ATSC Link-layer Protocol packets comprises a packet header and a packet payload, wherein generating an ATSC Link-layer Protocol packet of the plurality of ATSC Link-layer Protocol packets is conducted, such that the packet payload of said ATSC Link-layer Protocol comprises the image data.

Another embodiment may have a non-transitory digital storage medium having a computer program stored thereon to perform the method for decoding, comprising: receiving a plurality of ATSC Link-layer Protocol packets each of which comprising a packet header and a packet payload, wherein the packet payload of an ATSC Link-layer Protocol packet of the plurality of ATSC Link-layer Protocol packets comprises image data of one or more logos and/or of one or more icons, and decoding the packet payload of said ATSC Link-layer Protocol packet to acquire the image data, when said computer program is run by a computer.

Another embodiment may have a non-transitory digital storage medium having a computer program stored thereon to perform the method for generating a plurality of ATSC Link-layer Protocol packets, wherein the method comprises: receiving image data of one or more logos and/or of one or more icons, and generating the plurality of ATSC Link-layer Protocol packets, such that each of the plurality of ATSC Link-layer Protocol packets comprises a packet header and a packet payload, wherein generating an ATSC Link-layer Protocol packet of the plurality of ATSC Link-layer Protocol packets is conducted, such that the packet payload of said ATSC Link-layer Protocol comprises the image data, when said computer program is run by a computer.

An apparatus for decoding according to an embodiment is provided. The apparatus comprises an interface for receiving a plurality of ATSC Link-layer Protocol packets each of which comprising a packet header and a packet payload, wherein the packet payload of an ATSC Link-layer Protocol packet of the plurality of ATSC Link-layer Protocol packets comprises image data of one or more logos and/or of one or more icons. Moreover, the apparatus comprises a decoding unit for decoding the packet payload of said ATSC Link-layer Protocol packet to obtain the image data.

Moreover, an apparatus for generating a plurality of ATSC Link-layer Protocol packets according to an embodiment is provided. The apparatus comprises an interface for receiving image data of one or more logos and/or of one or more icons. Moreover, the apparatus comprises a packet generator for generating the plurality of ATSC Link-layer Protocol packets, such that each of the plurality of ATSC Link-layer Protocol packets comprises a packet header and a packet payload. The packet generator is configured to generate an ATSC Link-layer Protocol packet of the plurality of ATSC Link-layer Protocol packets, such that the packet payload of said ATSC Link-layer Protocol comprises the image data.

Furthermore, a data stream comprising a plurality of ATSC Link-layer Protocol packets according to an embodiment is provided. Each of the plurality of ATSC Link-layer Protocol packets comprises a packet header and a packet payload. The packet payload of each of the plurality of ATSC Link-layer Protocol packets comprises image data of one or more logos and/or of one or more icons.

Moreover, a method for decoding according to an embodiment is provided. The method comprises:
Receiving a plurality of ATSC Link-layer Protocol packets each of which comprising a packet header and a packet payload, wherein the packet payload of an ATSC Link-layer Protocol packet of the plurality of ATSC Link-layer Protocol packets comprises image data of one or more logos and/or of one or more icons. And:
Decoding the packet payload of said ATSC Link-layer Protocol packet to obtain the image data.

Furthermore, a method for generating a plurality of ATSC Link-layer Protocol packets according to an embodiment is provided. The method comprises:
Receiving image data of one or more logos and/or of one or more icons. And:
Generating the plurality of ATSC Link-layer Protocol packets, such that each of the plurality of ATSC Link-layer Protocol packets comprises a packet header and a packet payload.

Generating an ATSC Link-layer Protocol packet of the plurality of ATSC Link-layer Protocol packets is conducted, such that the packet payload of said ATSC Link-layer Protocol comprises the image data.

Moreover, a computer program for implementing one of the above-described methods, when being executed on a computer or signal processor, according to an embodiment is provided.

According to embodiment, logo and icon integration into ATSC is provided.

Some embodiments may, e.g., be applicable for all ATSC 3.0 services, including radio, TV, applications, etc.

According to an embodiment, an availability of logos for service selection and icons for app-specific user interface (UI) design over broadcast is realized.

In some embodiments, support for multiple variations, for example, for multiple graphics formats, screen sizes, etc., per logo/icon is realized.

According to some embodiments, mechanisms for efficient receiver updates, e.g., including a deletion of no longer available logos/icons, may, e.g., be realized.

In an embodiment, a support for separation of Logo/Icon metadata and actual transport of image data may, e.g., be provided, and all variants may., e.g., be carried out in separate Physical Layer Pipes (PLPs).

According to an embodiment, referencing of logos/icons from DRM service descriptions (e.g., from a LMT-R, see below), a dimensional service-selection, etc. (e.g., as an ATSC specific reference), and from TV/Application Services (e.g., via an URI string—as an alternative to Internet based online resources) may, e.g., be provided.

Embodiments realize to transmit logos and icons in ATSC, inter alia, e.g., for television broadcasts of TV programs, and/or, e.g., for broadcasts of DRM programs. Transmission and signaling may, e.g., be realized independently from the TV and radio programs.

E.g., for DRM, embodiments realize to transmit logos and icons independent from the DRM data stream, what achieves more efficiency and more flexibility.

In some embodiments, logos may, e.g., be optimized for being transmitted and being displayed on TV screens and high-resolution displays.

Embodiments realize a very efficient signaling. E.g., a linking of the logos and the icons with the programs may, e.g., be provided. Moreover, e.g., an intelligent updating/deleting mechanism of the logos and icons may, e.g., be provided.

Some embodiments realize to transmit radio programs in a way that users can really find them and can really distinguish them from TV programs.

An embodiment allows mobile terminals to switch between different transmission routes (depending on availability), wherein service layer decoding may, e.g., be used comprehensively. The terminals may, e.g., receive the same DRM radio standard also per ATSC (e.g., if the selected program is not directly available via DRM).

Embodiments realize a flexible transmission and signaling, optimized for ATSC TV programs and ATSC-DRM radio programs.

The transmission in a broadcast signal may, e.g., realized, when being provided, independently from logo lists provided by a receiver, and independent from access to the internet.

Embodiments may, e.g., be employed for devices and software for receiving, decoding and replaying of ATSC, and, e.g., may, e.g., be employed for devices and software for encoding, multiplexing and transmitting of ATSC.

### BRIEF DESCRIPTION OF THE DRAWINGS

Embodiments of the present invention will be detailed subsequently referring to the appended drawings, in which:

FIG. 1 illustrates an apparatus for decoding according to an embodiment.

FIG. 2 illustrates an apparatus for generating a plurality of ATSC Link-layer Protocol packets according to an embodiment.

FIG. 3 illustrates a data stream comprising a plurality of ATSC Link-layer Protocol packets according to an embodiment.

### DETAILED DESCRIPTION OF THE INVENTION

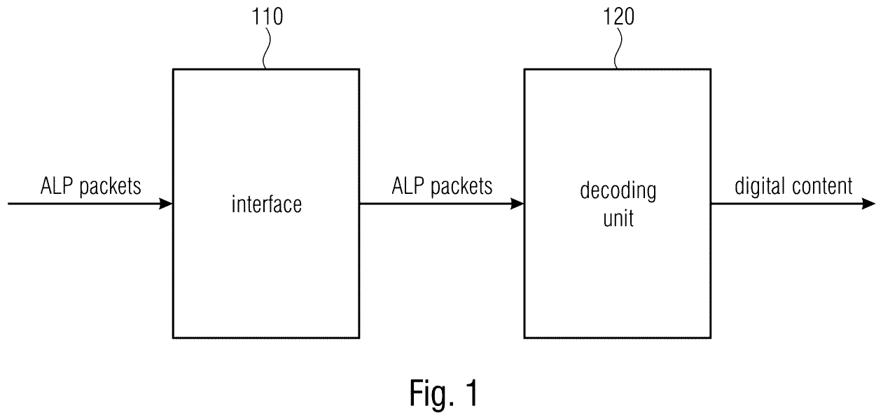

FIG. 1 illustrates an apparatus for decoding according to an embodiment.

The apparatus comprises an interface 110 for receiving a plurality of ATSC Link-layer Protocol packets each of which comprising a packet header and a packet payload, wherein the packet payload of an ATSC Link-layer Protocol packet of the plurality of ATSC Link-layer Protocol packets comprises image data of one or more logos and/or of one or more icons.

Moreover, the apparatus comprises a decoding unit 120 for decoding the packet payload of said ATSC Link-layer Protocol packet to obtain the image data.

According to an embodiment, the apparatus further may, e.g., comprise a renderer. The renderer may, e.g., be configured to output the image data or may, e.g., be configured to output derived image data being derived from the image data.

In an embodiment, each of the one or more logos is an image being associated with an ATSC service of a plurality of ATSC services and visualizes said ATSC service.

According to an embodiment, each of the plurality of ATSC services is an ATSC radio service and/or an ATSC TV service and/or an ATSC video service and/or an ATSC application service and/or another ATSC service.

In an embodiment, the one or more logos are two or more logos. The renderer may, e.g., be configured to output the image data of at least two of the two or more logos. The apparatus may, e.g., be configured to enable a user to select an ATSC service out of at least two of the plurality of ATSC services being associated with said at least two of the two or more logos.

According to an embodiment, each of the one or more icons is an image in a user interface or in an application. Each of the one or more icons is associated with a subject or object or action and visualizes said subject or object or action within the user interface or within the application, and visualizes said subject or object or action. For example, in contrast to the one or more logos, in an embodiment, each of the one or more icons is not associated with an ATSC service and does not visualize an ATSC service.

In an embodiment, the one or more icons are two or more icons. The renderer may, e.g., be configured to output the image data of at least two of the two or more icons. The apparatus may, e.g., be configured to enable a user to make a selection in the user interface or in the application by selecting at least one out of at least two options being associated with said at least two of the two or more icons.

According to an embodiment, the packet payloads of two or more of the plurality of ATSC Link-layer Protocol packets comprise image data for two or more variants of a logo of the one or more logos or of an icon the one or more icons. The decoding unit 120 may, e.g., be configured to decode the packet payload of at least one of the two or more of the plurality of ATSC Link-layer Protocol packets to obtain the image data for at least one of the two or more variants.

In an embodiment, one or more ATSC Link-layer Protocol packets of the plurality of ATSC Link-layer Protocol packets comprise one or more fragments of a Logo/Icon Table (LIT) data set. The one or more fragments of the Logo/Icon Table (LIT) data set indicate information on a plurality of logos and/or a plurality of icons, wherein the plurality of logos may, e.g., comprise the one or more logos and/or the plurality of icons may, e.g., comprise the one or more icons. The decoding unit 120 may, e.g., be configured to obtain information on the one or more logos and/or on the one or more icons from the Logo/Icon Table (LIT) data set.

According to an embodiment, the information on the plurality of logos and/or the plurality of icons may, e.g., comprise information on one or more variants of each of the plurality of logos and/or of the plurality of icons. The decoding unit 120 may, e.g., be configured to obtain information on the one or more variants of each of the one or more logos and/or of the one or more icons from the Logo/Icon Table (LIT) data set.

In an embodiment, the Logo/Icon Table (LIT) data set may, e.g., comprise information on two or more variants of at least one of the plurality of logos and/or of the plurality of icons. The decoding unit 120 may, e.g., be configured to obtain information on two or more variants of at least one of the one or more logos and/or of the one or more icons from the Logo/Icon Table (LIT) data set.

According to an embodiment, the information on each variant of the one or more variants of the plurality of logos and/or of the plurality of icons may, e.g., comprise an identifier of said variant, and further may, e.g., comprise an identifier of a physical layer pipe and/or an identifier of an ATSC Link-layer Protocol packet, which are associated with said variant. The decoding unit 120 may, e.g., be configured to, for each variant of at least one variant of the one or more variants of the one or more logos and/or of the one or more icons, to obtain the identifier of said variant, and to furthermore obtain the identifier of the physical layer pipe and/or the identifier of the ATSC Link-layer Protocol packet, which are associated with said variant.

In an embodiment, one or more further ATSC Link-layer Protocol packets of the plurality of ATSC Link-layer Protocol packets comprise one or more fragments of a Logo/Icon Variant (LIV) data set, being a variant of one of the plurality of logos or of one of the plurality of icons. The one or more fragments of the Logo/Icon Variant (LIV) data set comprise image data of said variant. The decoding unit 120 may, e.g., be configured to obtain the image data of said variant from the one or more fragments of the Logo/Icon Variant (LIV) data set.

According to an embodiment, the ATSC Link-layer Protocol packet, which is associated with said variant, may, e.g., comprise the Logo/Icon Variant (LIV) data set. The physical layer pipe being identified by the identifier of the physical layer pipe, which is associated with said variant, may, e.g., comprise said ATSC Link-layer Protocol packet. The decoding unit 120 may, e.g., be configured to obtain the Logo/Icon Variant (LIV) data set using the identifier of the physical layer pipe.

In an embodiment, at least one of the Logo/Icon Variant (LIV) data set and the Logo/Icon Table (LIT) data set may, e.g., comprise image type information indicating metadata depending on a characteristic of said variant. The decoding unit 120 may, e.g., be configured to obtain the metadata for the variant from the Logo/Icon Variant (LIV) data set and/or from the Logo/Icon Table (LIT) data set to decode the image being encoded within the image data of said variant.

According to an embodiment, the metadata depends on an encoding of said variant. The decoding unit 120 may, e.g., be configured to obtain the metadata which depends on the decoding of the variant from the Logo/Icon Variant (LIV) data set and/or from the Logo/Icon Table (LIT) data set to decode the image being encoded within the image data of the variant.

In an embodiment, the metadata for said variant may, e.g., comprise image type information indicating whether the image data of said variant is a bitmap graphic or whether the image data of said variant is a vector graphic. The decoding unit 120 may, e.g., be configured to obtain the image type information for the variant from the Logo/Icon Variant (LIV) data set and/or from the Logo/Icon Table (LIT) data set to decode the image being encoded within the image data of the variant.

According to an embodiment, if the image type information indicates that the image data of said variant is a bitmap graphic, at least one of the Logo/Icon Variant (LIV) data set and the Logo/Icon Table (LIT) data set may, e.g., comprise a pixel width and a pixel height of a bitmap image being encoded within the image data of the variant. If the image type information indicates that the image data of said variant is a bitmap graphic, the decoding unit 120 may, e.g., be configured to obtain the pixel width and the pixel height of a bitmap image being encoded within the image data of the variant from the Logo/Icon Variant (LIV) data set and/or from the Logo/Icon Table (LIT) data set to decode the bitmap image being encoded within the image data of the variant.

In an embodiment, if the image type information indicates that the image data of said variant is a vector graphic, at least one of the Logo/Icon Variant (LIV) data set and the Logo/Icon Table (LIT) data set may, e.g., comprise a minimum recommended number of a screen pixel width and/or may, e.g., comprise a minimum recommended number of a screen pixel height to render said variant. If the image type information indicates that the image data of said variant is a vector graphic, the apparatus may, e.g., be configured to obtain the minimum recommended number of the screen pixel width and/or the minimum recommended number of the screen pixel height from the Logo/Icon Variant (LIV) data set and/or from the Logo/Icon Table (LIT) data set to reproduce the image being encoded within the image data of the variant.

According to an embodiment, if the image type information indicates that the image data of said variant is a vector graphic, at least one of the Logo/Icon Variant (LIV) data set and the Logo/Icon Table (LIT) data set may, e.g., comprise information on a ratio between a shorter side of the vector graphic to a longer side of the vector graphic. If the image type information indicates that the image data of said variant is a vector graphic, the decoding unit 120 may, e.g., be configured to obtain the information on the ratio between the shorter side and the longer side of said variant from the Logo/Icon Variant (LIV) data set and/or from the Logo/Icon Table (LIT) data set.

In an embodiment, the decoding unit may, e.g., be configured to use the information on the ratio between the shorter side and the longer side of said variant to select a variant from one or more variants of one of the plurality of logos and/or of one of the plurality of icons.

According to an embodiment, the Logo/Icon Table (LIT) data set may, e.g., comprise information on a ratio between a shorter side of the vector graphic to a longer side of the vector graphic by indicating a number value for the shorter side, which defines the ratio between the shorter side and the longer side by assuming that a predefined reference value is assigned to the longer side.

In an embodiment, the number value for the shorter side is a first positive integer value. The predefined reference value is a second positive integer value.

According to an embodiment, if the image type information indicates that the image data of said variant is a vector graphic, the image data is represented as an SVG vector graphic.

In an embodiment, if the image type information indicates that the image data of said variant is a vector graphic, the SVG vector graphic is compressed. If the image type information indicates that the image data of said variant is a vector graphic, the decoding unit 120 may, e.g., be configured to decompress the compressed SVG vector graphic to obtain the uncompressed SVG graphic.

According to an embodiment, if the image type information indicates that the image data of said variant is a vector graphic, the SVG vector graphic is compressed with deflate compression. If the image type information indicates that the image data of said variant is a vector graphic, the decoding unit 120 may, e.g., be configured to decompress the compressed SVG vector graphic by decompressing the deflate compression to obtain the uncompressed SVG graphic.

In an embodiment, the packet payload of at least one of the plurality of ATSC Link-layer Protocol packets may, e.g., comprise compressed other content being compressed with deflate compression. The decoding unit 120 may, e.g., be configured to decompress said other content using a same decompression as used by the decoding unit 120 for decompressing the compressed SVG vector graphic.

According to an embodiment, if the metadata of said variant indicates that the image data of set variant is compressed, the image data of said variant is compressed with a compression algorithm supported by Journaline for image data compression. The decoding unit 120 may, e.g., be configured to obtain the image data of said variant using a decompression algorithm supported by Journaline for compressed image data decompression.

In an embodiment, the compression algorithm supported by Journaline for image data compression is a deflate compression algorithm.

According to an embodiment, one or more further ATSC Link-layer Protocol packets of the plurality of ATSC Link-layer Protocol packets comprise one or more fragments of a Link Mapping Table for services. The one or more fragments of the Link Mapping Table for services indicate one or more services of an ATSC transmission. At least one of the one or more fragments associates a logo of the one or more logos or an icon of the one or more icons with a service of the one or more services by indicating an identifier of said logo or of said icon and by associating said identifier of said logo or of said icon with said service. The decoding unit 120 may, e.g., be configured to identify the ATSC Link-layer Protocol packet which may, e.g., comprise content of one of the one or more services by analyzing the one or more fragments of the Link Mapping Table for services, and wherein the decoding unit 120 may, e.g., be configured to obtain said identifier of said logo or of said icon.

In an embodiment, the one or more fragments of the Link Mapping Table for services are one or more fragments of a Link Mapping Table for radio services. The one or more fragments of the Link Mapping Table for radio services indicate one or more radio services of the ATSC transmission. Said logo of the one or more logos or said icon of the one or more icons is associated with a radio service of the one or more radio services.

According to an embodiment, the one or more fragments of the Link Mapping Table for radio services are one or more fragments of a Link Mapping Table for Digital Radio Mondiale-Radio. The one or more fragments of the Link Mapping Table for Digital Radio Mondiale-Radio indicate one or more Digital Radio Mondiale radio services of the ATSC transmission. Said logo of the one or more logos or said icon of the one or more icons is associated with a Digital Radio Mondiale radio service of the one or more Digital Radio Mondiale radio services.

In an embodiment, one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission. At least one of the one or more fragments of the Link Mapping Table for Service Grouping associates a logo of the one or more logos or an icon of the one or more icons with a grouping of the one or more groupings by indicating an identifier of said logo or of said icon and by associating said identifier of said logo or of said icon with said grouping. The apparatus may, e.g., comprise an output interface for providing, depending on at least one of the one or more groupings, an output that depends on at least one of the plurality of services, and wherein the apparatus may, e.g., be configured to obtain said identifier of said logo or of said icon to output a presentation of said logo or of said icon using the output interface.

According to an embodiment, the one or more fragments of the Link Mapping Table for Service Grouping are one or more fragments of a Link Mapping Table for Radio Service Grouping. The one or more fragments of the Link Mapping Table for Radio Service Grouping indicate one or more groupings of a plurality of radio services of the ATSC transmission. The output interface may, e.g., be configured to provide, depending on at least one of the one or more groupings, an output that depends on at least one of the plurality of radio services.

In an embodiment, the one or more fragments of the Link Mapping Table for Service Grouping are one or more fragments of a Link Mapping Table for Digital Radio Mondiale-Radio Service Grouping. The one or more fragments of the Link Mapping Table for Digital Radio Mondiale-Radio Service Grouping indicate one or more groupings of a plurality of Digital Radio Mondiale radio services of the ATSC transmission. The output interface may, e.g., be configured to provide, depending on at least one of the one or more groupings, an output that depends on at least one of the plurality of Digital Radio Mondiale radio services.

According to an embodiment, the one or more fragments of the Link Mapping Table for Service Grouping associate two or more of the plurality of services with at least one of two or more categories, and/or with at least one of two or more properties. At least one of the one or more fragments of the Link Mapping Table for Service Grouping associates another logo of the one or more logos or another icon of the one or more icons with one of two or more categories, and/or with one of two or more properties by indicating an identifier of said other logo or of said other icon and by associating said other identifier of said other logo or of said other icon with said grouping.

In an embodiment, the apparatus may, e.g., be configured to employ the one or more logos for enabling a user to conduct a service selection in a television service guide.

According to an embodiment, the apparatus may, e.g., be configured to employ the one or more icons for enabling a user to conduct a selection in a user interface or in a broadcast application.

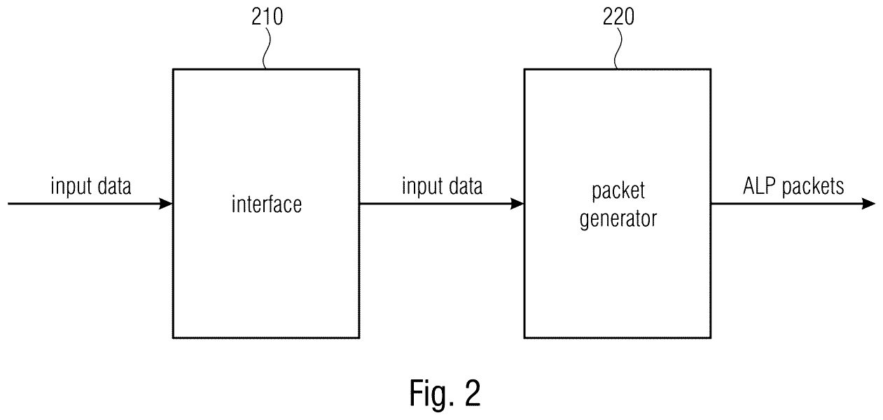

FIG. 2 illustrates an apparatus for generating a plurality of ATSC Link-layer Protocol packets according to an embodiment.

The apparatus comprises an interface 110 for receiving image data of one or more logos and/or of one or more icons.

Moreover, the apparatus comprises a packet generator 220 for generating the plurality of ATSC Link-layer Protocol packets, such that each of the plurality of ATSC Link-layer Protocol packets comprises a packet header and a packet payload.

The packet generator 220 is configured to generate an ATSC Link-layer Protocol packet of the plurality of ATSC Link-layer Protocol packets, such that the packet payload of said ATSC Link-layer Protocol comprises the image data.

According to an embodiment, each of the one or more logos is an image being associated with an ATSC service of a plurality of ATSC services and visualizes said ATSC service.

In an embodiment, each of the plurality of ATSC services is an ATSC radio service and/or an ATSC TV service and/or an ATSC video service and/or an ATSC application service and/or another ATSC service.

According to an embodiment, each of the one or more icons is an image in a user interface or in an application. Each of the one or more icons is associated with a subject or object or action and visualizes said subject or object or action within the user interface or within the application, and visualizes said subject or object or action.

In an embodiment, the packet generator 220 may, e.g., be configured to generate the plurality of ATSC Link-layer Protocol packets, such that the packet payloads of two or more of the plurality of ATSC Link-layer Protocol packets comprise image data for two or more variants of a logo of the one or more logos or of an icon the one or more icons.

According to an embodiment, the packet generator 220 may, e.g., be configured to generate the plurality of ATSC Link-layer Protocol packets, such that one or more ATSC Link-layer Protocol packets of the plurality of ATSC Link-layer Protocol packets comprise one or more fragments of a Logo/Icon Table (LIT) data set. The one or more fragments of the Logo/Icon Table (LIT) data set indicate information on a plurality of logos and/or a plurality of icons, wherein the plurality of logos may, e.g., comprise the one or more logos and/or the plurality of icons may, e.g., comprise the one or more icons.

In an embodiment, the information on the plurality of logos and/or the plurality of icons may, e.g., comprise information on one or more variants of each of the plurality of logos and/or of the plurality of icons.

According to an embodiment, the Logo/Icon Table (LIT) data set may, e.g., comprise information on two or more variants of at least one of the plurality of logos and/or of the plurality of icons.

In an embodiment, the information on each variant of the one or more variants of the plurality of logos and/or of the plurality of icons may, e.g., comprise an identifier of said variant and furthermore may, e.g., comprise an identifier of a physical layer pipe and/or an identifier of an ATSC Link-layer Protocol packet, which are associated with said variant.

According to an embodiment, the packet generator 220 may, e.g., be configured to generate the plurality of ATSC Link-layer Protocol packets, such that one or more further ATSC Link-layer Protocol packets of the plurality of ATSC Link-layer Protocol packets comprise one or more fragments of a Logo/Icon Variant (LIV) data set, being a variant of one of the plurality of logos or of one of the plurality of icons. The one or more fragments of the Logo/Icon Variant (LIV) data set comprise image data of said variant.

In an embodiment, the ATSC Link-layer Protocol packet, which is associated with said variant, may, e.g., comprise the Logo/Icon Variant (LIV) data set. The physical layer pipe being identified by the identifier of the physical layer pipe, which is associated with said variant, may, e.g., comprise said ATSC Link-layer Protocol packet.

According to an embodiment, at least one of the Logo/Icon Variant (LIV) data set and the Logo/Icon Table (LIT) data set may, e.g., comprise image type information indicating metadata depending on a characteristic of said variant.

In an embodiment, the metadata depends on an encoding of said variant.

According to an embodiment, the metadata for said variant may, e.g., comprise image type information indicating whether the image data of said variant is a bitmap graphic or whether the image data of said variant is a vector graphic.

In an embodiment, if the image type information indicates that the image data of said variant is a bitmap graphic, at least one of the Logo/Icon Variant (LIV) data set and the Logo/Icon Table (LIT) data set may, e.g., comprise a pixel width and a pixel height of a bitmap image being encoded within the image data of the variant.

According to an embodiment, if the image type information indicates that the image data of said variant is a vector graphic, at least one of the Logo/Icon Variant (LIV) data set and the Logo/Icon Table (LIT) data set may, e.g., comprise a minimum recommended number of a screen pixel width and/or may, e.g., comprise a minimum recommended number of a screen pixel height to render said variant.

In an embodiment, if the image type information indicates that the image data of said variant is a vector graphic, at least one of the Logo/Icon Variant (LIV) data set and the Logo/Icon Table (LIT) data set may, e.g., comprise information on a ratio between a shorter side of the vector graphic to a longer side of the vector graphic.

According to an embodiment, the decoding unit may, e.g., be configured to use the information on the ratio between the shorter side and the longer side of said variant to select a variant from one or more variants of one of the plurality of logos and/or of one of the plurality of icons.

In an embodiment, the Logo/Icon Table (LIT) data set may, e.g., comprise information on a ratio between a shorter side of the vector graphic to a longer side of the vector graphic by indicating a number value for the shorter side, which defines the ratio between the shorter side and the longer side by assuming that a predefined reference value is assigned to the longer side.

According to an embodiment, the number value for the shorter side is a first positive integer value. The predefined reference value is a second positive integer value.

In an embodiment, if the image type information indicates that the image data of said variant is a vector graphic, the image data is represented as an SVG vector graphic.

According to an embodiment, if the image type information indicates that the image data of said variant is a vector graphic, the SVG vector graphic is compressed.

In an embodiment, if the image type information indicates that the image data of said variant is a vector graphic, the SVG vector graphic is compressed with deflate compression.

According to an embodiment, the packet payload of at least one of the plurality of ATSC Link-layer Protocol packets may, e.g., comprise compressed other content being compressed with deflate compression.

In an embodiment, if the metadata of said variant indicates that the image data of set variant is compressed, the image data of said variant is compressed with a compression algorithm supported by Journaline for image data compression.

According to an embodiment, the compression algorithm supported by Journaline for image data compression is a deflate compression algorithm.

In an embodiment, one or more further ATSC Link-layer Protocol packets of the plurality of ATSC Link-layer Protocol packets comprise one or more fragments of a Link Mapping Table for services. The one or more fragments of the Link Mapping Table for services indicate one or more services of an ATSC transmission. At least one of the one or more fragments associates a logo of the one or more logos or an icon of the one or more icons with a service of the one or more services by indicating an identifier of said logo or of said icon and by associating said identifier of said logo or of said icon with said service.

According to an embodiment, the one or more fragments of the Link Mapping Table for services are one or more fragments of a Link Mapping Table for radio services. The one or more fragments of the Link Mapping Table for radio services indicate one or more radio services of the ATSC transmission. Said logo of the one or more logos or said icon of the one or more icons is associated with a radio service of the one or more radio services.

In an embodiment, the one or more fragments of the Link Mapping Table for radio services are one or more fragments of a Link Mapping Table for Digital Radio Mondiale-Radio. The one or more fragments of the Link Mapping Table for Digital Radio Mondiale-Radio indicate one or more Digital Radio Mondiale radio services of the ATSC transmission. Said logo of the one or more logos or said icon of the one or more icons is associated with a Digital Radio Mondiale radio service of the one or more Digital Radio Mondiale radio services.

According to an embodiment, one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission. At least one of the one or more fragments of the Link Mapping Table for Service Grouping associates a logo of the one or more logos or an icon of the one or more icons with a grouping of the one or more groupings by indicating an identifier of said logo or of said icon and by associating said identifier of said logo or of said icon with said grouping. The apparatus may, e.g., comprise an output interface for providing, depending on at least one of the one or more groupings, an output that depends on at least one of the plurality of services, and wherein the apparatus may, e.g., be configured to obtain said identifier of said logo or of said icon to output a presentation of said logo or of said icon using the output interface.

In an embodiment, the one or more fragments of the Link Mapping Table for Service Grouping are one or more fragments of a Link Mapping Table for Radio Service Grouping. The one or more fragments of the Link Mapping Table for Radio Service Grouping indicate one or more groupings of a plurality of radio services of the ATSC transmission. The output interface may, e.g., be configured to provide, depending on at least one of the one or more groupings, an output that depends on at least one of the plurality of radio services.

According to an embodiment, the one or more fragments of the Link Mapping Table for Service Grouping are one or more fragments of a Link Mapping Table for Digital Radio Mondiale-Radio Service Grouping. The one or more fragments of the Link Mapping Table for Digital Radio Mondiale-Radio Service Grouping indicate one or more groupings of a plurality of Digital Radio Mondiale radio services of the ATSC transmission. The output interface may, e.g., be configured to provide, depending on at least one of the one or more groupings, an output that depends on at least one of the plurality of Digital Radio Mondiale radio services.

In an embodiment, the one or more fragments of the Link Mapping Table for Service Grouping associate two or more of the plurality of services with at least one of two or more categories, and/or with at least one of two or more properties. At least one of the one or more fragments of the Link Mapping Table for Service Grouping associates another logo of the one or more logos or another icon of the one or more icons with one of two or more categories, and/or with one of two or more properties by indicating an identifier of said other logo or of said other icon and by associating said other identifier of said other logo or of said other icon with said grouping.

According to an embodiment, the one or more logos are suitable for enabling a user to conduct a service selection in a television service guide.

In an embodiment, the one or more icons are suitable for enabling a user to conduct a selection in a user interface or in a broadcast application.

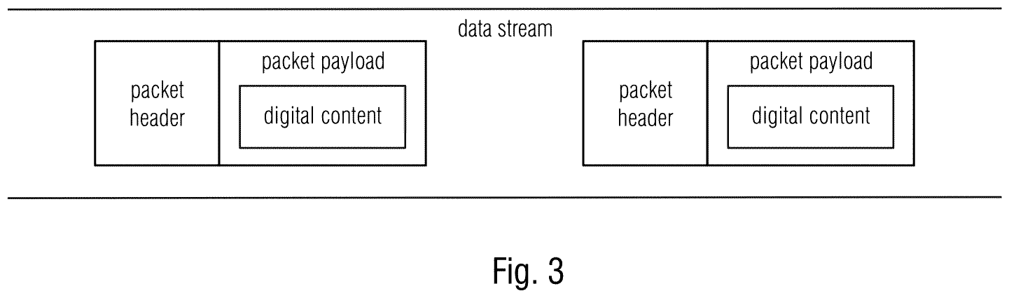

FIG. 3 illustrates a data stream comprising a plurality of ATSC Link-layer Protocol packets.

Each of the plurality of ATSC Link-layer Protocol packets comprises a packet header and a packet payload.

The packet payload of each of the plurality of ATSC Link-layer Protocol packets comprises image data of one or more logos and/or of one or more icons.

According to an embodiment, each of the one or more logos is an image being associated with an ATSC service of a plurality of ATSC services and visualizes said ATSC service.

In an embodiment, each of the plurality of ATSC services is an ATSC radio service and/or an ATSC TV service and/or an ATSC video service and/or an ATSC application service and/or another ATSC service.

According to an embodiment, each of the one or more icons is an image in a user interface or in an application. Each of the one or more icons is associated with a subject or object or action and visualizes said subject or object or action within the user interface or within the application, and visualizes said subject or object or action.

In an embodiment, the data stream may, e.g., comprise of two or more ATSC Link-layer Protocol packets of the plurality of ATSC Link-layer Protocol packets, which comprise image data for two or more variants of a logo of the one or more logos or of an icon the one or more icons.

According to an embodiment, one or more ATSC Link-layer Protocol packets of the plurality of ATSC Link-layer Protocol packets comprise one or more fragments of a Logo/Icon Table (LIT) data set. The one or more fragments of the Logo/Icon Table (LIT) data set indicate information on a plurality of logos and/or a plurality of icons, wherein the plurality of logos may, e.g., comprise the one or more logos and/or the plurality of icons may, e.g., comprise the one or more icons.

In an embodiment, the information on the plurality of logos and/or the plurality of icons may, e.g., comprise information on one or more variants of each of the plurality of logos and/or of the plurality of icons.

According to an embodiment, the Logo/Icon Table (LIT) data set may, e.g., comprise information on two or more variants of at least one of the plurality of logos and/or of the plurality of icons.

In an embodiment, the information on each variant of the one or more variants of the plurality of logos and/or of the plurality of icons may, e.g., comprise an identifier of said variant and furthermore may, e.g., comprise an identifier of a physical layer pipe and/or an identifier of an ATSC Link-layer Protocol packet, which are associated with said variant.

According to an embodiment, one or more further ATSC Link-layer Protocol packets of the plurality of ATSC Link-layer Protocol packets comprise one or more fragments of a Logo/Icon Variant (LIV) data set, being a variant of one of the plurality of logos or of one of the plurality of icons. The one or more fragments of the Logo/Icon Variant (LIV) data set comprise image data of said variant.

In an embodiment, the ATSC Link-layer Protocol packet, which is associated with said variant, may, e.g., comprise the Logo/Icon Variant (LIV) data set. The physical layer pipe being identified by the identifier of the physical layer pipe, which is associated with said variant, may, e.g., comprise said ATSC Link-layer Protocol packet.

According to an embodiment, at least one of the Logo/Icon Variant (LIV) data set and the Logo/Icon Table (LIT) data set may, e.g., comprise image type information indicating metadata depending on a characteristic of said variant.

In an embodiment, the metadata depends on an encoding of said variant.

According to an embodiment, the metadata for said variant may, e.g., comprise image type information indicating whether the image data of said variant is a bitmap graphic or whether the image data of said variant is a vector graphic.

In an embodiment, if the image type information indicates that the image data of said variant is a bitmap graphic, at least one of the Logo/Icon Variant (LIV) data set and the Logo/Icon Table (LIT) data set may, e.g., comprise a pixel width and a pixel height of a bitmap image being encoded within the image data of the variant.

According to an embodiment, if the image type information indicates that the image data of said variant is a vector graphic, at least one of the Logo/Icon Variant (LIV) data set and the Logo/Icon Table (LIT) data set may, e.g., comprise a minimum recommended number of a screen pixel width and/or may, e.g., comprise a minimum recommended number of a screen pixel height to render said variant.

In an embodiment, if the image type information indicates that the image data of said variant is a vector graphic, at least one of the Logo/Icon Variant (LIV) data set and the Logo/Icon Table (LIT) data set may, e.g., comprise information on a ratio between a shorter side of the vector graphic to a longer side of the vector graphic.

According to an embodiment, the decoding unit may, e.g., be configured to use the information on the ratio between the shorter side and the longer side of said variant to select a variant from one or more variants of one of the plurality of logos and/or of one of the plurality of icons.

In an embodiment, the Logo/Icon Table (LIT) data set may, e.g., comprise information on a ratio between a shorter side of the vector graphic to a longer side of the vector graphic by indicating a number value for the shorter side, which defines the ratio between the shorter side and the longer side by assuming that a predefined reference value is assigned to the longer side.

According to an embodiment, the number value for the shorter side is a first positive integer value. The predefined reference value is a second positive integer value.

In an embodiment, if the image type information indicates that the image data of said variant is a vector graphic, the image data is represented as an SVG vector graphic.

According to an embodiment, if the image type information indicates that the image data of said variant is a vector graphic, the SVG vector graphic is compressed.

In an embodiment, if the image type information indicates that the image data of said variant is a vector graphic, the SVG vector graphic is compressed with deflate compression.

According to an embodiment, the packet payload of at least one of the plurality of ATSC Link-layer Protocol packets may, e.g., comprise compressed other content being compressed with deflate compression.

In an embodiment, if the metadata of said variant indicates that the image data of set variant is compressed, the image data of said variant is compressed with a compression algorithm supported by Journaline for image data compression.

According to an embodiment, the compression algorithm supported by Journaline for image data compression is a deflate compression algorithm.

In an embodiment, one or more further ATSC Link-layer Protocol packets of the plurality of ATSC Link-layer Protocol packets comprise one or more fragments of a Link Mapping Table for services. The one or more fragments of the Link Mapping Table for services indicate one or more services of an ATSC transmission. At least one of the one or more fragments associates a logo of the one or more logos or an icon of the one or more icons with a service of the one or more services by indicating an identifier of said logo or of said icon and by associating said identifier of said logo or of said icon with said service.

According to an embodiment, the one or more fragments of the Link Mapping Table for services are one or more fragments of a Link Mapping Table for radio services. The one or more fragments of the Link Mapping Table for radio services indicate one or more radio services of the ATSC transmission. Said logo of the one or more logos or said icon of the one or more icons is associated with a radio service of the one or more radio services.

In an embodiment, the one or more fragments of the Link Mapping Table for radio services are one or more fragments of a Link Mapping Table for Digital Radio Mondiale-Radio. The one or more fragments of the Link Mapping Table for Digital Radio Mondiale-Radio indicate one or more Digital Radio Mondiale radio services of the ATSC transmission. Said logo of the one or more logos or said icon of the one or more icons is associated with a Digital Radio Mondiale radio service of the one or more Digital Radio Mondiale radio services.

According to an embodiment, one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission. At least one of the one or more fragments of the Link Mapping Table for Service Grouping associates a logo of the one or more logos or an icon of the one or more icons with a grouping of the one or more groupings by indicating an identifier of said logo or of said icon and by associating said identifier of said logo or of said icon with said grouping. The apparatus may, e.g., comprise an output interface for providing, depending on at least one of the one or more groupings, an output that depends on at least one of the plurality of services, and wherein the apparatus may, e.g., be configured to obtain said identifier of said logo or of said icon to output a presentation of said logo or of said icon using the output interface.

In an embodiment, the one or more fragments of the Link Mapping Table for Service Grouping are one or more fragments of a Link Mapping Table for Radio Service Grouping. The one or more fragments of the Link Mapping Table for Radio Service Grouping indicate one or more groupings of a plurality of radio services of the ATSC transmission. The output interface may, e.g., be configured to provide, depending on at least one of the one or more groupings, an output that depends on at least one of the plurality of radio services.

According to an embodiment, the one or more fragments of the Link Mapping Table for Service Grouping are one or more fragments of a Link Mapping Table for Digital Radio Mondiale-Radio Service Grouping. The one or more fragments of the Link Mapping Table for Digital Radio Mondiale-Radio Service Grouping indicate one or more groupings of a plurality of Digital Radio Mondiale radio services of the ATSC transmission. The output interface may, e.g., be configured to provide, depending on at least one of the one or more groupings, an output that depends on at least one of the plurality of Digital Radio Mondiale radio services.

In an embodiment, the one or more fragments of the Link Mapping Table for Service Grouping associate two or more of the plurality of services with at least one of two or more categories, and/or with at least one of two or more properties. At least one of the one or more fragments of the Link Mapping Table for Service Grouping associates another logo of the one or more logos or another icon of the one or more icons with one of two or more categories, and/or with one of two or more properties by indicating an identifier of said other logo or of said other icon and by associating said other identifier of said other logo or of said other icon with said grouping.

According to an embodiment, the one or more logos are suitable for enabling a user to conduct a service selection in a television service guide.

In an embodiment, the one or more icons are suitable for enabling a user to conduct a selection in a user interface or in a broadcast application.

Moreover, a system is provided.

The system comprises an apparatus according to one of the above-described embodiments for generating a plurality of ATSC Link-layer Protocol packets.

Moreover, the system comprises an apparatus according to one of the above-described embodiments for decoding, wherein the apparatus for decoding may, e.g., be configured to receive and decode the plurality of ATSC Link-layer Protocol packets.

In the following, particular embodiments of the present invention are described.

Some embodiments relate to new and inventive extensions of ATSC.

In the following, a broadcast of logos and icons according to some embodiments is described.

On receivers with graphic displays, such as televisions, higher-end radio sets, or handheld devices, it can be useful for presentation of information to have graphic images available to enrich and visualize the information shown. Such graphic images can serve as Logos representing organizations or services, for instance as part of a service guide, or as Icons in graphical user interfaces.

This section describes how such Logos/Icons can be available as part of an ATSC transmission, without requiring separate Internet connections. The number of Logos/Icons to be carried for the various purposes over the air in an ATSC multiplex can be large, so their efficient signaling and delivery is important. Direct delivery in ALP packets is a way to achieve such efficiency and can make such graphic objects available to television sets, radios, data receivers, and other types of receivers using a common delivery mechanism.

Up to 65,534 individual Logos/Icons can be carried in an ATSC multiplex.

At first Logo/Icon Variants are described.

A Logo/Icon may need to be presented in several UI locations and device environments. For example, a logo representing a radio service needs to be clearly recognizable on a small radio or handheld graphics screen, but should also be presented in best possible quality on a large-scale TV screen. Therefore the Logo/Icon delivery system allows for every broadcast Logo/Icon to be made available in multiple Variants. All Variants of a Logo/Icon depict the same general content (e.g. a specific station logo) and are accessible under a single ID. But every Variant of such a Logo/Icon represents the content using individual resolution, aspect ratio, and format (bitmap or vector graphics) parameters or choices. While Service guides and other ATSC signaling services will refer to Logos and Icons using their unique identifiers, it is up to receivers to select the specific Variants of the referenced Logos/Icons that best suit their respective hardware and UI requirements. Up to 64 Variants may be defined for each Logo or Icon.

The full set of Logos/Icons available in an ATSC 3.0 transmission is listed in a Logo/Icon Table (LIT, see below), allowing a receiver to quickly verify the presence and revision number of a specific Logo/Icon. The LIT also describes all available Variants of each Logo/Icon, as well as its associated metadata, enabling receivers to locate and decode specific image content through selection of image renditions optimal to their needs and broadcast as Logo/Icon Variant (LIV, see below) data.

Every Logo/Icon Variant (LIV) not only contains the image content itself but also associated metadata describing the Variant. The metadata comprises parameters such as the associated Logo/Icon ID (unique within the ATSC 3.0 emission), the image type (bitmap or vector graphics), the graphics file format (e.g. JPEG, PNG, SVG) in the form of a media type value 0, the resolution for bitmaps or aspect ratio for vector graphics, etc.

When support for Logos/Icons via ATSC 3.0 transmission is implemented, at least PNG and JPEG graphics shall be supported, and APNG (a backward-compatible PNG extension to support animation) and SVG vector graphics should be supported. If SVG vector graphics are used, the compression format [8] shall be applied before embedding files into LIV Fragments. Other graphics formats with their respective media-type strings may be used but may lack wide-spread decoder support. The media-type strings used in ATSC 3.0 for the core graphics formats are listed in Table 8.1:

TABLE 8.1
Media-type strings for ATSC 3.0 core graphics formats

| Graphic file format | Media-type string |
|---|---|
| PNG | image/png |
| APNG (decodable as still | image/apng |
| image by any PNG decoder) | |
| JPEG | image/jpeg |
| SVG (with deflate compression) | image/x-svgx |

Now, a Logo/Icon Transport Data Structure is described.

There are two components involved in the signaling and transport of broadcast Logos/Icons in the ATSC multiplex: The Logo/Icon Table (LIT), listing and describing all available Logos/Icons and their Variants, and a set of Logo/Icon Variants (LIV), each carrying the actual image content of one Variant of a Logo/Icon.

The Logo/Icon Table (LIT) shall carry all the information necessary to locate and describe all the Logos/Icons and their respective Variants available in the ATSC 3.0 emission. The LIT can be broken into Fragments if the content exceeds the capacity of a single ALP packet, or if parts of the LIT should be carried in separate PLPs along with other associated information (e.g., separated by broadcast operators). All the information for all the Variants of a single Logo or Icon shall be carried together in a single LIT Fragment and shall not be repeated elsewhere. LIT Fragments may be carried in PLPs and ALP Sub-streams that do not carry Logo/Icon Variants (LIV).

References to Logos/Icons in LMT-R, LMT-R-SG, and other ATSC 3.0 data structures shall include pointers to the PLP and/or ALP Sub-stream in which an LIT Fragment describing a referenced Logo/Icon is carried.

A Logo/Icon Variant (LIV) containing the image content and metadata of a Variant may be carried in one or more ALP packets. An LIV may be divided into Fragments and carried in multiple ALP packets when its size exceeds the payload capacity of a single ALP packet. All the ALP packets carrying a single LIV shall be transported in sequence in the same PLP and ALP Sub-stream. Different Variants of a single Logo/Icon (i.e., sharing the same Logo/Icon ID) are not required to be carried in the same PLP and ALP Sub-stream combination or in the PLP/ALP Sub-stream that carries the associated LIT Fragment. If multiple LIVs are carried in a single PLP/ALP Sub-Stream, appropriate repetition rate management can be applied, for example, to ensure that basic Variants of a Logo/Icon are being transmitted at a higher rate for quicker availability, while higher resolution Variants may be repeated less often. Logo/Icon Variants (with or without LIT Fragments) shall be carried in ALP Sub-streams used exclusively for that purpose.

Next, a Logo/Icon Table (LIT) is described.

Each Logo/Icon Table (LIT) Fragment shall comprise a table comparable to an LMT that lists the contents of one or more Logos/Icons and all of those Logo's or Icon's Variants. Any Logo/Icon (identified by its Logo/Icon ID), including all its Variants, shall be described in a single LIT Fragment within an ATSC 3.0 multiplex. An LIT Fragment shall fit within a single ALP packet payload, meaning that it cannot exceed 65,535 bytes in size. The information for more than one Logo/Icon (identified by its Logo/Icon ID) may be included in an LIT Fragment, with the limitation on doing so being the maximum payload size of an ALP packet. More than one ALP packet with LIT Fragment content may be carried in a single ALP Sub-stream.

The body sections of LIT Fragments should be compressed using gzip 0, however compression shall be applied to an LIT Fragment only if doing so results in overall reduction of the size of the Fragment.

All Fragments constituting the complete LIT should be repeated at least once every second; but in any case, they shall be repeated at a rate of at least once every 5 seconds. When present, the LIT should be broadcast at the same rate as the SLT.

At least the LIT Fragment with lowest index value carried in a given PLP shall carry a table indicating the locations and revision statuses of all Fragments, including those carried outside the current PLP.

When carrying a Logo/Icon Table Fragment, an ALP packet's Base Header packet type value shall be ‘100’ (Link Layer Signaling Packet); only single-packet-headers shall be applied to the packet. Such packets shall not be segmented or concatenated and shall be limited to 65,535 bytes of payload prior to application of any compression. Thus, in the headers of ALP packets carrying LIT Fragments, PC shall be set to ‘0’, and HM shall be set to ‘1’. The value of the LIT Extension Headers of ALP packets carrying LIT Fragments, which are defined in Table 8.2, shall be as given in Table 8.1. The syntax of the LIT Fragment itself shall be as given in Table 8.2 and semantics of the LIT Fragment shall be as given following Table 8.2.

TABLE 8.2
ALP Packet Additional Header for Signaling, Values for LIT

| Fields in Additional Header for Signaling | No. of bits | Value |
|---|---|---|
| signaling_type | 8 | 0x05 |
| signaling_type_extension | 16 | 0xFFFF |
| signaling_format | 2 | 00 |
| signaling_encoding | 2 | 00 |

TABLE 8.3
Syntax for Logo/Icon Table (LIT) Fragment

| Syntax | No. of bits | Format |
|---|---|---|
| logo_table_fragment { | | |
| Fragment Management Section: | | |
| lit_version | 2 | uimsbf |
| reserved | 2 | ‘11’ |
| lit_data_revision | 4 | uimsbf |
| num_ fragments_minus1 | 11 | uimsbf |
| fragment_index | 11 | uimsbf |
| fragment_data_revision | 4 | uimsbf |
| fragment_extension_flag | 1 | bslbf |
| fragment_compression_flag | 1 | bslbf |
| revision_table_use_flag | 1 | bslbf |
| reserved | 3 | ‘111’ |
| Start of LIT Fragment “Body Section”: | | |
| if (revision_table_use_flag==1) { | | |
| for (i = 0; i <= num_fragments_minus1; ++i) { | | |
| reserved | 2 | ‘11’ |
| rt_fragment_plp_id | 6 | uimsbf |
| rt_fragment_data_revision | 4 | uimsbf |
| } | | |
| if (is_even_number(num_fragments_minus1)) { | | |
| rt_byte_alignment | 4 | ‘1111’ |
| } | | |
| } | | |
| Start of LIT Fragment “Payload Section”: | | |
| num_logos_minus1 | 14 | uimsbf |
| reserved | 2 | ‘11’ |
| for (i=0; i<=num_logos _minus1; i++) { | | |
| logo_id | 16 | uimsbf |
| num_logo_ variants_minus1 | 6 | uimsbf |
| reserved | 2 | ‘11’ |
| for (j=0; j<=num_logo_variants_minus1; j++) { | | |
| variant_id | 6 | uimsbf |
| variant_revision | 6 | uimsbf |
| variant_plp_id | 6 | uimsbf |
| variant_alp_sid | 8 | uimsbf |
| reserved | 2 | ‘11’ |
| image_type | 4 | uimsbf |
| media_type_size_minus1 | 8 | uimsbf |
| media_type | 8 × (size) | ascii |
| if (image_type == 0 ) { /* bitmap graphic */ | | |
| pixel_width | 16 | uimsbf |
| pixel_height | 16 | uimsbf |
| } | | |
| if (image_type == 1) { /* vector graphic */ | | |
| landscape_flag | 1 | bslbf |
| shorter_side_length_factor | 15 | uimsbf |
| min_recommended_pixel_width | 16 | uimsbf |
| } | | |
| if (image_type >= 2) { /* for future extension */ | | |
| image_config_size | 8 | uimsbf |
| image_config_data | 8*(size) | bslbf |
| } | | |
| image_data_size | 24 | uimsbf |
| } | | |
| } | | |
| Fragment Extension Section: | | |
| if (fragment_extension_flag == 1) { | | |
| fragment_extension_size_minus1 | 8 | uimsbf |
| fragment_extension | 8 × (size) | bslbf |
| } | | |
| End of LIT Fragment “Body Section”: | | |
| fragment_crc | 16 | uimsbf |
| } | | |

lit_version—the version of the Logo/Icon Table (LIT) protocol in use. For Logo/Icon Table Fragments constructed according to the provisions of the current document, its value shall be ‘0’. If other lit_version values than ‘0’ are not understood by entities processing LIT Fragments, such LIT Fragments indicating non-understood lit_version values other than ‘0’ shall be ignored.

lit_data_revision—shall indicate the current revision number of the Logo/Icon Table. Its value shall be carried identically by all LIT Fragments carried in the ATSC transmission. Whenever the fragment_data_revision parameter value changes in at least one LIT Fragment representing the LIT, or if the overall number of LIT Fragments indicated by the num_fragments_minus1 parameter changes, the value of lit_revision shall increment by one for all LIT Fragments, rolling over from a value of ‘15’ to a value of ‘0’. If necessary, changes to LIT Fragments shall be delayed so that the occurrence of each value of lit_revision remains stable for not less than 15 seconds.

num_fragments_minus1—shall have a value one less than the total number of LIT Fragments comprising the entire Logo/Icon Table with the same lit_version value. It shall have a range from 0 to 2047 decimal, corresponding to 1 to 2048 LIT Fragments.

fragment_index—shall indicate the unique index value of the current LIT Fragment within the sequence of LIT Fragments representing the full Logo/Icon Table. The Logo/Icon Table shall be composed of exactly one Fragment for every value of fragment_index from 0 to num_fragments_minus1.

fragment_data_revision—shall indicate the current revision of the data carried in this LIT Fragment. Whenever any data carried in this Fragment between the ‘Start of LIT Fragment “Payload Section’” marker and the ‘End of LIT Fragment “Body Section’” marker changes, the value of its fragment_data_revision shall increment by one, rolling over from a value of ‘15’ to a value of ‘0’.

fragment_extension_flag—when set to ‘1’ shall indicate that the fragment_extension_size_minus1 and fragment_extension fields are present in this LIT Fragment. Otherwise, its value shall be set to ‘0’.

fragment_compression_flag—when set to a value of ‘1’ shall indicate that the Fragment in which it is carried is compressed, starting from the “Start of LIT fragment ‘Body Section’” marker to the “End of LIT fragment ‘Body Section’” marker, using gzip 0; otherwise it shall indicate that the Fragment is uncompressed. Compression shall only be applied if the result is a decrease in the size of the Fragment, and should be applied in those cases.

revision_table_use_flag—when set to a value of ‘1’ shall indicate that this LIT Fragment carries a revision table. The revision table simplifies change management of the LIT. If all LIT Fragments are carried within the same PLP, then the use of a revision table is optional. If LIT Fragments are carried within multiple PLP, then at least the LIT Fragment with the lowest fragment_index in each PLP shall carry a revision table. The use of a revision table in other LIT Fragments is optional.

rt_fragment_plp_id—shall be the value that identifies the PLP that carries the LIT Fragment. It shall have a range of 0 to 63 decimal.

rt_fragment_data_revision—shall be the value of the fragment_data_revision parameter of the LIT Fragment.

rt_byte_alignment—shall be used to ensure byte alignment of the revision table. Byte alignment is needed if the revision table has an odd number of (12-bit) entries.

num_logos_minus1—shall have a value one less than the total number of Logos and Icons for which information is provided in the LIT Fragment in which it is carried. It shall have a range from 0 to 16383 decimal, corresponding to 1 to 16384 Logos and Icons.

logo_id—shall be the numeric identifier from 1 to 65535 decimal that uniquely identifies a Logo to visually represent the Multiplex or Service entity with which it is associated, from the set of available broadcast Logos. The value 0 may indicate ‘no Logo/Icon’ and shall not be assigned to an actual Logo/Icon.

num_logo_variants_minus1—shall have a value one less than the total number of Logo/Icon Variants in the image set identified by the logo_id in the ‘for’ loop in which they all are found. It shall have a range from 0 to 63 decimal, corresponding to 1 to 64 Logo/Icon Variants.

variant_id—shall be the value that identifies the Logo/Icon Variant for which descriptive information is carried in the ‘for’ loop in which the variant_id appears. It shall have a range of 0 to 63 decimal, corresponding to 1 to 64 Variants.

variant_revision—shall indicate the current revision number of the data carried in this Variant ‘for’ loop. The format and description may, e.g., be be equivalent to the Imt-r_data_revision parameter of an LMT-R.

variant_plp_id—shall indicate the number of the PLP in which is found the ALP Sub-stream that carries the Logo or Icon Variant indicated by the related Logo or Icon ID and Variant ID values.

variant_alp_sid—shall indicate the number of the ALP Sub-stream that carries the Logo/Icon Variant indicated by the related logo_id and variant_id values.

image_type—shall indicate the type of image contained in the Variant according to the values in Table 8.3.

TABLE 8.4
Image Type Values

| Value | Image Type |
|---|---|
| 0 | bitmap graphic |
| 1 | vector graphic |
| 2-3 | reserved |

media_type_size_minus1—shall have a value of 1 less than the number of bytes carried in the media_type field.

media_type—shall identify the format of the image information contained in the file that carries the enumerated Variant of the graphic entity that is identified by the logo_icon_id field. The media_type value shall be that specified in the IANA register for Media Types per RFC 6838. 0

pixel_width—shall indicate the width of the Logo/Icon Variant in number of pixels when the image_type value of the Logo/Icon Variant indicates a type of image expressed as a bitmag graphic (i.e., image_type=0).

pixel_height—shall indicate the height of the Logo/Icon Variant in number of pixels when the image_type value of the Logo/Icon Variant indicates a type of image expressed as a bitmap graphic (i.e., image_type=0).
landscape_flag—when set to ‘1’ shall indicate that the Logo/Icon Variant is in landscape orientation (i.e. longer sides of the image are at the top and at the bottom. Otherwise the value shall be set to ‘0’, which indicates that the Logo/Icon Variant is in portrait orientation (i.e. longer sides of the image are vertical) or that the Logo/Icon Variant is a square. Only present if the image_type value of the Logo/Icon Variant indicates a type of image expressed as a vector graphic (i.e., image_type=1).
shorter_side_length_factor—shall indicate the ratio of the width of the shorter side to longer side of the vector graphic expressed as a value 1 to 25200 decimal. The value represents the length units of the shorter side and is calculated by assigning a length of 25200 units to the longer side. This indicative value allows the receiver to select a suitable Logo/Icon Variant; it shall not be used to calculate the final rendering/screen pixel size of the Logo/Icon Variant. Only present if the image_type value of the Logo/Icon Variant indicates a type of image expressed as a vector graphic (i.e., image_type=1).

min_recommended_pixel_width—shall indicate the minimum recommended number of screen pixels (representing the width of the image) to render this Logo/Icon Variant. The indicative value allows the receiver to select a suitable Logo/Icon Variant with a suitable level of graphical details. Only present if the image_type value of the Logo/Icon Variant indicates a type of image expressed as a vector graphic (i.e., image_type=1).

image_config_size—shall indicate the number of bytes carried in the image_config_data field.

image_config_data—shall carry the data describing the image for image_type values larger than 1. The content of image_config_data field is currently undefined and shall be defined with every addition of a new supported image_type value. A decoder not supporting the specified image_type value must ignore this parameter.

image_data_size—shall indicate the size in bytes of the file carrying the Logo/Icon Variant identified by the combination of logo_id and variant_id by which it is referenced.

fragment_extension_size_minus1—shall indicate the number of bytes included in the associated fragment_extension field, with values from 0 to 255 decimal corresponding to a fragment_extension field carrying from 1 to 256 bytes, respectively.

fragment_extension—shall be a field carrying one more than the number of bytes of data indicated in the fragment_extension_size_minus1 field and related to the LIT Fragment in which it is found. The content of this field is intended for future definition and shall be ignored by decoders that do not know how to interpret it.

fragment_crc—shall be a 16-bit Cyclic Redundancy Check (CRC-16) value calculated according to 0, with its value calculated using as input the full content of the LIT Fragment in which it is found, i.e. the block of data including the field values from lit_version through just before fragment_crc.

Now, a Logo/Icon Variant Format is described.

When carrying a Logo/Icon Variant (LIV) Fragment, an ALP packet's Base Header packet_type value shall be ‘011’ (Packet Type Extension, Logo/Icon Variant); only single-packet-headers shall be applied to it. Such packets shall not be segmented or concatenated and shall be limited to 65,535 bytes of payload. No compression shall be applied to such packets. Thus, in the headers of ALP packets carrying LIV Fragments, PC shall be set to ‘0’, and HM shall be set to ‘1’. The syntax of the LIV Fragment itself shall be as given in Table 8.4 and semantics of the LIV Fragment shall be as given following Table 8.4.

TABLE 8.6
Syntax for Logo/Icon Variant (LIV) Fragment

| Syntax | No. of bits | Format |
|---|---|---|
| logo_icon_variant_fragment { | | |
| Fragment Management Section: | | |
| liv_version | 2 | uimsbf |
| reserved | 2 | ‘11’ |
| liv_data_revision | 4 | uimsbf |
| num_fragments_minus1 | 11 | uimsbf |
| fragment_index | 11 | uimsbf |
| fragment_data_revision | 4 | uimsbf |
| fragment_extension_flag | 1 | bslbf |
| reserved | 5 | ‘11111’ |
| Start of LIV Fragment “Body Section”: | | |
| Start of LIV Fragment “Payload Section”: | | |
| logo_id | 16 | uimsbf |
| variant_id | 6 | uimsbf |
| variant_revision | 6 | uimsbf |
| LIV Metadata Section: | | |
| if (fragment_index == 0) { /* only in first fragment of every Variant */ | | |
| image_type | 4 | uimsbf |
| media_type_size_minus1 | 8 | uimsbf |
| media_type | 8 × (size) | ascii |
| if (image_type == 0 ) { /* bitmap graphic */ | | |
| pixel_width | 16 | uimsbf |
| pixel_height | 16 | uimsbf |
| } | | |
| if (image_type == 1) { /* vector graphic */ | | |
| landscape_flag | 1 | bslbf |
| shorter_side_length_factor | 15 | uimsbf |
| min_recommended_pixel_width | 16 | uimsbf |
| } | | |
| if (image_type >= 2) { /* for future extension */ | | |
| image_config_size | 8 | uimsbf |
| image_config_data | 8*(size) | bslbf |
| } | | |
| image_data_size | 24 | uimsbf |
| } | | |
| else { | | |
| reserved | 4 | ‘1111’ |
| } | | |
| LIV Image Data Section: | | |
| image_fragment_data_ size_minus1 | 16 | |
| image_fragment_data | 8 × (size) | |
| Fragment Extension Section: | | |
| if (fragment_extension_flag == 1) { | | |
| fragment_extension_size_minus1 | 8 | uimsbf |
| fragment_extension | 8 × (size) | bslbf |
| } | | |
| End of LIT Fragment “Body Section”: | | |
| fragment_crc | 16 | uimsbf |
| } | | |

liv_version—the version of the Logo/Icon Variant (LIV) protocol in use. For Logo Icon Variant Fragments constructed according to the provisions of the current document, its value shall be ‘0’. If other liv_version values than ‘0’ are not understood by entities processing LIV Fragments, such LIV Fragments indicating non-understood liv_version values other than ‘0’ shall be ignored.

liv_data_revision—shall indicate the current revision number of the Logo/Icon Variant. Its value shall be carried identically by all LIV Fragments of a Variant. The format and description shall be equivalent to the Imt-r_data_revision parameter of an LMT-R. If necessary, changes to LIV Fragments shall be delayed so that the occurrence of each value of liv revision remains stable for not less than 15 seconds.

num_fragments_minus1—shall have a value one less than the total number of LIV Fragments comprising the entire Logo/Icon Variant with the same liv_version value. It shall have a range from 0 to 2047 decimal, corresponding to 1 to 2048 LIV Fragments.

fragment_index—shall indicate the unique index value of the current LIV Fragment within the sequence of LIV Fragments representing the full Logo/Icon Variant. The LIV table shall be composed of exactly one Fragment for every value of fragment_index from 0 to num_fragments_minus1.

fragment_data_revision—shall indicate the current revision of the data carried in this LIV Fragment. Whenever any data carried in this Fragment between the ‘Start of LIV Fragment “Payload Section’” marker and the ‘End of LIV Fragment “Body Section’” marker changes, the value of its fragment_data_revision shall increment by one, rolling over from a value of ‘15’ to a value of ‘0’.

fragment_extension_flag—when set to ‘1’ shall indicate that the fragment_extension_size_minus1 and fragment_extension fields are present in this LIV Fragment. Otherwise, its value shall be set to ‘0’.

logo_id—shall be the numeric identifier from 1 to 65535 decimal that uniquely identifies a Logo to visually represent the Multiplex or Service entity with which it is associated, from the set of available broadcast Logos. The value 0 may indicate ‘no Logo/Icon’ and shall not be assigned to an actual Logo/Icon.

variant_id—for the parameter format and description see above.

variant_revision—for the parameter format and description see above

image_type—for the parameter format and description see above.

image_type_size_minus1—for the parameter format and description see above.

media_type—for the parameter format and description see above.

pixel_width—for the parameter format and description see above.

pixel_height—for the parameter format and description see above.

landscape_flag—for the parameter format and description see above.

shorter_side_length_factor—for the parameter format and description see above

min_recommended_pixel_width—for the parameter format and description see above.

image_config_size—for the parameter format and description see above.

image_config_data—for the parameter format and description see above.

image_fragment_data_size_minus1—shall indicate one less than the number of bytes of image_fragment_data present in the LIV Fragment

image_fragment_data—carries a portion of the image content; to obtain the original image content, the image_fragment_data sections of all num_fragements_minus_1 fragments representing this Variant must be concatenated

fragment_extension_size_minus1—shall indicate the number of bytes included in the associated fragment_extension field, with values from 0 to 255 decimal corresponding to a fragment_extension field carrying from 1 to 256 bytes, respectively.

fragment_extension—shall be a field carrying one more than the number of bytes of data indicated in the fragment_extension_size_minus1 field and related to the LIV Fragment in which it is found. The content of this field is intended for future definition and shall be ignored by decoders that do not know how to interpret it.

fragment_crc—shall be a 16-bit Cyclic Redundancy Check (CRC-16) value calculated according to 0, with its value calculated using as input the full content of the LIV Fragment in which it is found, i.e. the block of data including the field values from liv_version through just before fragment_crc.

Next, Referencing Logos/Icons is described.

Two methods are provided for referencing Logos/Icons within an ATSC 3.0 multiplex: Binary Logo/Icon references and URI (Uniform Resource Locator) based strings.

Binary Logo/Icon references are for example utilized by LMT-R and by LMT-R-SG service description tables. Such a binary reference is efficiently encoded and defines two elements: the Logo/Icon ID and the PLP carrying the LIT Fragment, which describes the referenced Logo/Icon ID and contains the description and locations of all its Variants.

The URI based references follow the format of online references to Logo/Icon resources, e.g., available on the Internet, as deployed by the ATSC 3.0 TV Service guide. The format to reference broadcast Logo/Icon in these places is as follows:

$$atsc - lit : // < logo\_id > [ \text{:<} logo\_plp \_id > ]$$

### Examples

atsc-lit://15456:5
atsc-lit://5434

The URI parameters are as follows:

logo_id—shall be the numeric identifier from 1 to 65535 decimal that uniquely identifies a Logo to visually represent the Multiplex or Service entity with which it is associated, from the set of available broadcast Logos. The value 0 may indicate ‘no Logo/Icon’ and shall not be assigned to an actual Logo/Icon.

logo_pip_id—shall be present when the single_logo_substream_flag is set to ‘1’ and shall be the value that identifies the PLP that carries the LIT Fragment describing the Logo with which it is associated. It shall have a range of 0 to 63 decimal.

The parameter logo_pip_id may, for example, be optional.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] “ATSC Standard: Link-Layer Protocol (A/330)”, 2022-03, published 31 Mar. 2022.

[2] ATSC: “ATSC Standard: Physical Layer Protocol,” Doc. A/322:2017, Advanced Television Systems Committee, Washington, D.C., 6 Jun. 2017.
[3] ETSI: TS 102 821, “Digital Radio Mondiale (DRM); Distribution and Communications Protocol (DCP),” V1.4.1 (2012-10), European Telecommunications Standards Institute, Valbonne—Sophia Antipolis France, October 2012.
[4] ETSI: ES 201 980, “Digital Radio Mondiale (DRM); System Specification,” V4.2.1 (2020-11), European Telecommunications Standards Institute, Valbonne—Sophia Antipolis France, November 2020.
[5] ETSI: TS 102 820, “Digital Radio Mondiale (DRM); Multiplex Distribution Interface (MDI),” V4.1.1 (2016-03), European Telecommunications Standards Institute, Valbonne—Sophia Antipolis France, March 2016.
[6] ETSI: TS 101 968, “Digital Radio Mondiale (DRM) Data Application Directory,” European Telecommunications Standards Insititute, Valbonne—Sophia Antipolis France, November 2020.
[7] ITU-T, “V.41 Data Communication Over the Telephone Network, Code-Independent Error-Control System,” 1993.
[8] IETF: “DEFLATE Compressed Data Format Specification, version 1.3”, Internet Engineering Task Force, Reston, VA, May 1996, http://tools.ietf.org/html/rfc1951.
[9] ISO/IEC: 10646, “Information Technology—Universal Coded Character Set (UCS)” International Organization for Standardization/International Electrotechnical Commission, Geneva, Switzerland, December 2020.
[10] EP 1658689 A1, “Radio comprising a Display for Text Information referring to other Text Information Objects”.
[11] IETF: RFC 6838, “Media Type Specifications and Registration Procedures”, Internet Engineering Task Force, Reston, VA, January 2013. http://tools.ietf.org/html/rfc6838.

1. An apparatus for decoding, comprising:
an interface for receiving a plurality of ATSC Link-layer Protocol packets each of which comprising a packet header and a packet payload, wherein the packet payload of an ATSC Link-layer Protocol packet of the plurality of ATSC Link-layer Protocol packets comprises image data of one or more logos and/or of one or more icons, and
a decoding unit for decoding the packet payload of said ATSC Link-layer Protocol packet to acquire the image data.

2. An apparatus according to claim 1,
wherein the apparatus further comprises a renderer,
wherein the renderer is configured to output the image data or is configured to output derived image data being derived from the image data.

3. An apparatus according to claim 1,
wherein each of the one or more logos is an image being associated with an ATSC service of a plurality of ATSC services and visualizes said ATSC service.

4. An apparatus according to claim 3,
wherein each of the plurality of ATSC services is an ATSC radio service and/or an ATSC TV service and/or an ATSC video service and/or an ATSC application service and/or another ATSC service.

5. An apparatus according to claim 2,
wherein the one or more logos are two or more logos,
wherein the renderer is configured to output the image data of at least two of the two or more logos,
wherein the apparatus is configured to enable a user to select an ATSC service out of at least two of the plurality of ATSC services being associated with said at least two of the two or more logos.

6. An apparatus according to claim 1,
wherein each of the one or more icons is an image in a user interface or in an application,
wherein each of the one or more icons is associated with a subject or object or action and visualizes said subject or object or action within the user interface or within the application, and visualizes said subject or object or action.

7. An apparatus according to claim 2,
wherein the one or more icons are two or more icons,
wherein the renderer is configured to output the image data of at least two of the two or more icons,
wherein the apparatus is configured to enable a user to make a selection in the user interface or in the application by selecting at least one out of at least two options being associated with said at least two of the two or more icons.

8. An apparatus according to claim 1,
wherein the packet payloads of two or more of the plurality of ATSC Link-layer Protocol packets comprise image data for two or more variants of a logo of the one or more logos or of an icon the one or more icons,
wherein the decoding unit is configured to decode the packet payload of at least one of the two or more of the plurality of ATSC Link-layer Protocol packets to acquire the image data for at least one of the two or more variants.

9. An apparatus according to claim 1,
wherein one or more ATSC Link-layer Protocol packets of the plurality of ATSC Link-layer Protocol packets comprise one or more fragments of a Logo/Icon Table data set,
wherein the one or more fragments of the Logo/Icon Table data set indicate information on a plurality of logos and/or a plurality of icons, wherein the plurality of logos comprises the one or more logos and/or the plurality of icons comprises the one or more icons,
wherein the decoding unit is configured to acquire information on the one or more logos and/or on the one or more icons from the Logo/Icon Table data set.

10. An apparatus according to claim 9,
wherein the information on the plurality of logos and/or the plurality of icons comprises information on one or more variants of each of the plurality of logos and/or of the plurality of icons,
wherein the decoding unit is configured to acquire information on the one or more variants of each of the one or more logos and/or of the one or more icons from the Logo/Icon Table data set.

11. An apparatus according to claim 10,
wherein the Logo/Icon Table data set comprises information on two or more variants of at least one of the plurality of logos and/or of the plurality of icons, and
wherein the decoding unit is configured to acquire information on two or more variants of at least one of the one or more logos and/or of the one or more icons from the Logo/Icon Table data set.

12. An apparatus according to claim 10,
wherein the information on each variant of the one or more variants of the plurality of logos and/or of the plurality of icons comprises an identifier of said variant, and further comprises an identifier of a physical layer pipe and/or an identifier of an ATSC Link-layer Protocol packet, which are associated with said variant, and
wherein the decoding unit is configured to, for each variant of at least one variant of the one or more variants of the one or more logos and/or of the one or more icons, to acquire the identifier of said variant, and to furthermore acquire the identifier of the physical layer pipe and/or the identifier of the ATSC Link-layer Protocol packet, which are associated with said variant.

13. An apparatus according to claim 10,
wherein one or more further ATSC Link-layer Protocol packets of the plurality of ATSC Link-layer Protocol packets comprise one or more fragments of a Logo/Icon Variant data set, being a variant of one of the plurality of logos or of one of the plurality of icons,
wherein the one or more fragments of the Logo/Icon Variant data set comprise image data of said variant, and
wherein the decoding unit is configured to acquire the image data of said variant from the one or more fragments of the Logo/Icon Variant data set.

14. An apparatus according to claim 12,
wherein one or more further ATSC Link-layer Protocol packets of the plurality of ATSC Link-layer Protocol packets comprise one or more fragments of a Logo/Icon Variant data set, being a variant of one of the plurality of logos or of one of the plurality of icons,
wherein the one or more fragments of the Logo/Icon Variant data set comprise image data of said variant, and
wherein the decoding unit is configured to acquire the image data of said variant from the one or more fragments of the Logo/Icon Variant data set,
wherein the ATSC Link-layer Protocol packet, which is associated with said variant, comprises the Logo/Icon Variant data set,
wherein the physical layer pipe being identified by the identifier of the physical layer pipe, which is associated with said variant, comprises said ATSC Link-layer Protocol packet, and
wherein the decoding unit is configured to acquire the Logo/Icon Variant data set using the identifier of the physical layer pipe.

15. An apparatus according to claim 13,
wherein at least one of the Logo/Icon Variant data set and the Logo/Icon Table data set comprises image type information indicating metadata depending on a characteristic of said variant,
wherein the decoding unit is configured to acquire the metadata for the variant from the Logo/Icon Variant data set and/or from the Logo/Icon Table data set to decode the image being encoded within the image data of said variant.

16. An apparatus according to claim 15,
wherein the metadata depends on an encoding of said variant,
wherein the decoding unit is configured to acquire the metadata which depends on the decoding of the variant from the Logo/Icon Variant data set and/or from the Logo/Icon Table data set to decode the image being encoded within the image data of the variant.

17. An apparatus according to claim 15,
wherein the metadata for said variant comprises image type information indicating whether the image data of said variant is a bitmap graphic or whether the image data of said variant is a vector graphic,
wherein the decoding unit is configured to acquire the image type information for the variant from the Logo/Icon Variant data set and/or from the Logo/Icon Table data set to decode the image being encoded within the image data of the variant.

18. An apparatus according to claim 17,
wherein, if the image type information indicates that the image data of said variant is a bitmap graphic, at least one of the Logo/Icon Variant data set and the Logo/Icon Table data set comprises a pixel width and a pixel height of a bitmap image being encoded within the image data of the variant,
wherein, if the image type information indicates that the image data of said variant is a bitmap graphic, the decoding unit is configured to acquire the pixel width and the pixel height of a bitmap image being encoded within the image data of the variant from the Logo/Icon Variant data set and/or from the Logo/Icon Table data set to decode the bitmap image being encoded within the image data of the variant.

19. An apparatus according to claim 17,
wherein, if the image type information indicates that the image data of said variant is a vector graphic, at least one of the Logo/Icon Variant data set and the Logo/Icon Table data set comprises a minimum recommended number of a screen pixel width and/or comprises a minimum recommended number of a screen pixel height to render said variant,
wherein, if the image type information indicates that the image data of said variant is a vector graphic, the apparatus is configured to acquire the minimum recommended number of the screen pixel width and/or the minimum recommended number of the screen pixel height from the Logo/Icon Variant data set and/or from the Logo/Icon Table data set to reproduce the image being encoded within the image data of the variant.

20. An apparatus according to claim 17,
wherein, if the image type information indicates that the image data of said variant is a vector graphic, at least one of the Logo/Icon Variant data set and the Logo/Icon Table data set comprises information on a ratio between a shorter side of the vector graphic to a longer side of the vector graphic,
wherein, if the image type information indicates that the image data of said variant is a vector graphic, the decoding unit is configured to acquire the information on the ratio between the shorter side and the longer side of said variant from the Logo/Icon Variant data set and/or from the Logo/Icon Table data set.

21. An apparatus according to claim 20,
wherein the decoding unit is configured to use the information on the ratio between the shorter side and the longer side of said variant to select a variant from one or more variants of one of the plurality of logos and/or of one of the plurality of icons.

22. An apparatus according to claim 20,
wherein the Logo/Icon Table data set comprises information on a ratio between a shorter side of the vector graphic to a longer side of the vector graphic by indicating a number value for the shorter side, which defines the ratio between the shorter side and the longer side by assuming that a predefined reference value is assigned to the longer side.

23. An apparatus according to claim 22,
wherein the number value for the shorter side is a first positive integer value, and
wherein the predefined reference value is a second positive integer value.

24. An apparatus according to claim 17,
wherein, if the image type information indicates that the image data of said variant is a vector graphic, the image data is represented as an SVG vector graphic.

25. An apparatus according to claim 24,
wherein, if the image type information indicates that the image data of said variant is a vector graphic, the SVG vector graphic is compressed,
wherein, if the image type information indicates that the image data of said variant is a vector graphic, the decoding unit is configured to decompress the compressed SVG vector graphic to acquire the uncompressed SVG graphic.

26. An apparatus according to claim 25,
wherein, if the image type information indicates that the image data of said variant is a vector graphic, the SVG vector graphic is compressed with deflate compression,
wherein, if the image type information indicates that the image data of said variant is a vector graphic, the decoding unit is configured to decompress the compressed SVG vector graphic by decompressing the deflate compression to acquire the uncompressed SVG graphic.

27. An apparatus according to claim 26,
wherein the packet payload of at least one of the plurality of ATSC Link-layer Protocol packets comprises compressed other content being compressed with deflate compression, and
wherein the decoding unit is configured to decompress said other content using a same decompression as used by the decoding unit for decompressing the compressed SVG vector graphic.

28. An apparatus according to claim 27,
wherein, if the metadata of said variant indicates that the image data of set variant is compressed, the image data of said variant is compressed with a compression algorithm supported by Journaline for image data compression,
wherein the decoding unit is configured to acquire the image data of said variant using a decompression algorithm supported by Journaline for compressed image data decompression.

29. An apparatus according to claim 28,
wherein the compression algorithm supported by Journaline for image data compression is a deflate compression algorithm.

30. An apparatus according to claim 1,
wherein one or more further ATSC Link-layer Protocol packets of the plurality of ATSC Link-layer Protocol packets comprise one or more fragments of a Link Mapping Table for services,
wherein the one or more fragments of the Link Mapping Table for services indicate one or more services of an ATSC transmission,
wherein at least one of the one or more fragments associates a logo of the one or more logos or an icon of the one or more icons with a service of the one or more services by indicating an identifier of said logo or of said icon and by associating said identifier of said logo or of said icon with said service,
wherein the decoding unit is configured to identify the ATSC Link-layer Protocol packet which comprises content of one of the one or more services by analyzing the one or more fragments of the Link Mapping Table for services, and wherein the decoding unit is configured to acquire said identifier of said logo or of said icon.

31. An apparatus according to claim 30,
wherein the one or more fragments of the Link Mapping Table for services are one or more fragments of a Link Mapping Table for radio services,
wherein the one or more fragments of the Link Mapping Table for radio services indicate one or more radio services of the ATSC transmission,
wherein said logo of the one or more logos or said icon of the one or more icons is associated with a radio service of the one or more radio services.

32. An apparatus according to claim 31,
wherein the one or more fragments of the Link Mapping Table for radio services are one or more fragments of a Link Mapping Table for Digital Radio Mondiale-Radio,
wherein the one or more fragments of the Link Mapping Table for Digital Radio Mondiale-Radio indicate one or more Digital Radio Mondiale radio services of the ATSC transmission,
wherein said logo of the one or more logos or said icon of the one or more icons is associated with a Digital Radio Mondiale radio service of the one or more Digital Radio Mondiale radio services.

33. An apparatus according to claim 1,
wherein one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission,
wherein at least one of the one or more fragments of the Link Mapping Table for Service Grouping associates a logo of the one or more logos or an icon of the one or more icons with a grouping of the one or more groupings by indicating an identifier of said logo or of said icon and by associating said identifier of said logo or of said icon with said grouping,
wherein the apparatus comprises an output interface for providing, depending on at least one of the one or more groupings, an output that depends on at least one of the plurality of services, and wherein the apparatus is configured to acquire said identifier of said logo or of said icon to output a presentation of said logo or of said icon using the output interface.

34. An apparatus according to claim 33,
wherein the one or more fragments of the Link Mapping Table for Service Grouping are one or more fragments of a Link Mapping Table for Radio Service Grouping,
wherein the one or more fragments of the Link Mapping Table for Radio Service Grouping indicate one or more groupings of a plurality of radio services of the ATSC transmission,
wherein the output interface is configured to provide, depending on at least one of the one or more groupings, an output that depends on at least one of the plurality of radio services.

35. An apparatus according to claim 34,
wherein the one or more fragments of the Link Mapping Table for Service Grouping are one or more fragments of a Link Mapping Table for Digital Radio Mondiale-Radio Service Grouping,
wherein the one or more fragments of the Link Mapping Table for Digital Radio Mondiale-Radio Service Grouping indicate one or more groupings of a plurality of Digital Radio Mondiale radio services of the ATSC transmission,
wherein the output interface is configured to provide, depending on at least one of the one or more groupings, an output that depends on at least one of the plurality of Digital Radio Mondiale radio services.

36. An apparatus according to claim 33,
wherein the one or more fragments of the Link Mapping Table for Service Grouping associate two or more of the plurality of services with at least one of two or more categories, and/or with at least one of two or more properties,
wherein at least one of the one or more fragments of the Link Mapping Table for Service Grouping associates another logo of the one or more logos or another icon of the one or more icons with one of two or more categories, and/or with one of two or more properties by indicating an identifier of said other logo or of said other icon and by associating said other identifier of said other logo or of said other icon with said grouping.

37. An apparatus according to claim 1,
wherein the apparatus is configured to employ the one or more logos for enabling a user to conduct a service selection in a television service guide.

38. An apparatus according to claim 1,
wherein the apparatus is configured to employ the one or more icons for enabling a user to conduct a selection in a user interface or in a broadcast application.

39. An apparatus for generating a plurality of ATSC Link-layer Protocol packets, wherein the apparatus comprises:
an interface for receiving image data of one or more logos and/or of one or more icons, and
a packet generator for generating the plurality of ATSC Link-layer Protocol packets, such that each of the plurality of ATSC Link-layer Protocol packets comprises a packet header and a packet payload,
wherein the packet generator is configured to generate an ATSC Link-layer Protocol packet of the plurality of ATSC Link-layer Protocol packets, such that the packet payload of said ATSC Link-layer Protocol comprises the image data.

40. An apparatus according to claim 39,
wherein each of the one or more logos is an image being associated with an ATSC service of a plurality of ATSC services and visualizes said ATSC service.

41. An apparatus according to claim 40,
wherein each of the plurality of ATSC services is an ATSC radio service and/or an ATSC TV service and/or an ATSC video service and/or an ATSC application service and/or another ATSC service.

42. An apparatus according to claim 39,
wherein each of the one or more icons is an image in a user interface or in an application,
wherein each of the one or more icons is associated with a subject or object or action and visualizes said subject or object or action within the user interface or within the application, and visualizes said subject or object or action.

43. An apparatus according to claim 39,
wherein the packet generator is configured to generate the plurality of ATSC Link-layer Protocol packets, such that the packet payloads of two or more of the plurality of ATSC Link-layer Protocol packets comprise image data for two or more variants of a logo of the one or more logos or of an icon the one or more icons.

44. An apparatus according to claim 39,
wherein the packet generator is configured to generate the plurality of ATSC Link-layer Protocol packets, such that one or more ATSC Link-layer Protocol packets of the plurality of ATSC Link-layer Protocol packets comprise one or more fragments of a Logo/Icon Table data set,
wherein the one or more fragments of the Logo/Icon Table data set indicate information on a plurality of logos and/or a plurality of icons, wherein the plurality of logos comprises the one or more logos and/or the plurality of icons comprises the one or more icons.

45. An apparatus according to claim 44,
wherein the information on the plurality of logos and/or the plurality of icons comprises information on one or more variants of each of the plurality of logos and/or of the plurality of icons.

46. An apparatus according to claim 45,
wherein the Logo/Icon Table data set comprises information on two or more variants of at least one of the plurality of logos and/or of the plurality of icons.

47. An apparatus according to claim 45,
wherein the information on each variant of the one or more variants of the plurality of logos and/or of the plurality of icons comprises an identifier of said variant and furthermore comprises an identifier of a physical layer pipe and/or an identifier of an ATSC Link-layer Protocol packet, which are associated with said variant.

48. An apparatus according to claim 45,
wherein the packet generator is configured to generate the plurality of ATSC Link-layer Protocol packets, such that one or more further ATSC Link-layer Protocol packets of the plurality of ATSC Link-layer Protocol packets comprise one or more fragments of a Logo/Icon Variant data set, being a variant of one of the plurality of logos or of one of the plurality of icons,
wherein the one or more fragments of the Logo/Icon Variant data set comprise image data of said variant.

49. An apparatus according to claim 47,
wherein the packet generator is configured to generate the plurality of ATSC Link-layer Protocol packets, such that one or more further ATSC Link-layer Protocol packets of the plurality of ATSC Link-layer Protocol packets comprise one or more fragments of a Logo/Icon Variant data set, being a variant of one of the plurality of logos or of one of the plurality of icons,
wherein the one or more fragments of the Logo/Icon Variant data set comprise image data of said variant,
wherein the ATSC Link-layer Protocol packet, which is associated with said variant, comprises the Logo/Icon Variant data set, and
wherein the physical layer pipe being identified by the identifier of the physical layer pipe, which is associated with said variant, comprises said ATSC Link-layer Protocol packet.

50. An apparatus according to claim 48,
wherein at least one of the Logo/Icon Variant data set and the Logo/Icon Table data set comprises image type information indicating metadata depending on a characteristic of said variant.

51. An apparatus according to claim 50,
wherein the metadata depends on an encoding of said variant.

52. An apparatus according to claim 50,
wherein the metadata for said variant comprises image type information indicating whether the image data of said variant is a bitmap graphic or whether the image data of said variant is a vector graphic.

53. An apparatus according to claim 52,
wherein, if the image type information indicates that the image data of said variant is a bitmap graphic, at least one of the Logo/Icon Variant data set and the Logo/Icon Table data set comprises a pixel width and a pixel height of a bitmap image being encoded within the image data of the variant.

54. An apparatus according to claim 52,
wherein, if the image type information indicates that the image data of said variant is a vector graphic, at least one of the Logo/Icon Variant data set and the Logo/Icon Table data set comprises a minimum recommended number of a screen pixel width and/or comprises a minimum recommended number of a screen pixel height to render said variant.

55. An apparatus according to claim 52,
wherein, if the image type information indicates that the image data of said variant is a vector graphic, at least one of the Logo/Icon Variant data set and the Logo/Icon Table data set comprises information on a ratio between a shorter side of the vector graphic to a longer side of the vector graphic.

56. An apparatus according to claim 55,
wherein the decoding unit is configured to use the information on the ratio between the shorter side and the longer side of said variant to select a variant from one or more variants of one of the plurality of logos and/or of one of the plurality of icons.

57. An apparatus according to claim 55,
wherein the Logo/Icon Table data set comprises information on a ratio between a shorter side of the vector graphic to a longer side of the vector graphic by indicating a number value for the shorter side, which defines the ratio between the shorter side and the longer side by assuming that a predefined reference value is assigned to the longer side.

58. An apparatus according to claim 57,
wherein the number value for the shorter side is a first positive integer value, and
wherein the predefined reference value is a second positive integer value.

59. An apparatus according to claim 52,
wherein, if the image type information indicates that the image data of said variant is a vector graphic, the image data is represented as an SVG vector graphic.

60. An apparatus according to claim 59,
wherein, if the image type information indicates that the image data of said variant is a vector graphic, the SVG vector graphic is compressed.

61. An apparatus according to claim 60,
wherein, if the image type information indicates that the image data of said variant is a vector graphic, the SVG vector graphic is compressed with deflate compression.

62. An apparatus according to claim 61,
wherein the packet payload of at least one of the plurality of ATSC Link-layer Protocol packets comprises compressed other content being compressed with deflate compression.

63. An apparatus according to claim 62,
wherein, if the metadata of said variant indicates that the image data of set variant is compressed, the image data of said variant is compressed with a compression algorithm supported by Journaline for image data compression.

64. An apparatus according to claim 63,
wherein the compression algorithm supported by Journaline for image data compression is a deflate compression algorithm.

65. An apparatus according to claim 39,
wherein one or more further ATSC Link-layer Protocol packets of the plurality of ATSC Link-layer Protocol packets comprise one or more fragments of a Link Mapping Table for services,
wherein the one or more fragments of the Link Mapping Table for services indicate one or more services of an ATSC transmission,
wherein at least one of the one or more fragments associates a logo of the one or more logos or an icon of the one or more icons with a service of the one or more services by indicating an identifier of said logo or of said icon and by associating said identifier of said logo or of said icon with said service.

66. An apparatus according to claim 65,
wherein the one or more fragments of the Link Mapping Table for services are one or more fragments of a Link Mapping Table for radio services,
wherein the one or more fragments of the Link Mapping Table for radio services indicate one or more radio services of the ATSC transmission,
wherein said logo of the one or more logos or said icon of the one or more icons is associated with a radio service of the one or more radio services.

67. An apparatus according to claim 66,
wherein the one or more fragments of the Link Mapping Table for radio services are one or more fragments of a Link Mapping Table for Digital Radio Mondiale-Radio,
wherein the one or more fragments of the Link Mapping Table for Digital Radio Mondiale-Radio indicate one or more Digital Radio Mondiale radio services of the ATSC transmission,
wherein said logo of the one or more logos or said icon of the one or more icons is associated with a Digital Radio Mondiale radio service of the one or more Digital Radio Mondiale radio services.

68. An apparatus according to claim 39,
wherein one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission,
wherein at least one of the one or more fragments of the Link Mapping Table for Service Grouping associates a logo of the one or more logos or an icon of the one or more icons with a grouping of the one or more groupings by indicating an identifier of said logo or of said icon and by associating said identifier of said logo or of said icon with said grouping,
wherein the apparatus comprises an output interface for providing, depending on at least one of the one or more groupings, an output that depends on at least one of the plurality of services, and wherein the apparatus is configured to acquire said identifier of said logo or of said icon to output a presentation of said logo or of said icon using the output interface.

69. An apparatus according to claim 68,
wherein the one or more fragments of the Link Mapping Table for Service Grouping are one or more fragments of a Link Mapping Table for Radio Service Grouping,
wherein the one or more fragments of the Link Mapping Table for Radio Service Grouping indicate one or more groupings of a plurality of radio services of the ATSC transmission,
wherein the output interface is configured to provide, depending on at least one of the one or more groupings, an output that depends on at least one of the plurality of radio services.

70. An apparatus according to claim 69,
wherein the one or more fragments of the Link Mapping Table for Service Grouping are one or more fragments of a Link Mapping Table for Digital Radio Mondiale-Radio Service Grouping,
wherein the one or more fragments of the Link Mapping Table for Digital Radio Mondiale-Radio Service Grouping indicate one or more groupings of a plurality of Digital Radio Mondiale radio services of the ATSC transmission,
wherein the output interface is configured to provide, depending on at least one of the one or more groupings, an output that depends on at least one of the plurality of Digital Radio Mondiale radio services.

71. An apparatus according to claim 68,
wherein the one or more fragments of the Link Mapping Table for Service Grouping associate two or more of the plurality of services with at least one of two or more categories, and/or with at least one of two or more properties,
wherein at least one of the one or more fragments of the Link Mapping Table for Service Grouping associates another logo of the one or more logos or another icon of the one or more icons with one of two or more categories, and/or with one of two or more properties by indicating an identifier of said other logo or of said other icon and by associating said other identifier of said other logo or of said other icon with said grouping.

72. An apparatus according to claim 45,
wherein the one or more logos are suitable for enabling a user to conduct a service selection in a television service guide.

73. An apparatus according to claim 45,
wherein the one or more icons are suitable for enabling a user to conduct a selection in a user interface or in a broadcast application.

74. A data stream comprising a plurality of ATSC Link-layer Protocol packets,
wherein each of the plurality of ATSC Link-layer Protocol packets comprises a packet header and a packet payload,
wherein the packet payload of each of the plurality of ATSC Link-layer Protocol packets comprises image data of one or more logos and/or of one or more icons.

75. A data stream according to claim 74,
wherein each of the one or more logos is an image being associated with an ATSC service of a plurality of ATSC services and visualizes said ATSC service.

76. A data stream according to claim 75,
wherein each of the plurality of ATSC services is an ATSC radio service and/or an ATSC TV service and/or an ATSC video service and/or an ATSC application service and/or another ATSC service.

77. A data stream according to claim 74,
wherein each of the one or more icons is an image in a user interface or in an application,
wherein each of the one or more icons is associated with a subject or object or action and visualizes said subject or object or action within the user interface or within the application, and visualizes said subject or object or action.

78. A data stream according to claim 74,
wherein the data stream comprises of two or more ATSC Link-layer Protocol packets of the plurality of ATSC Link-layer Protocol packets, which comprise image data for two or more variants of a logo of the one or more logos or of an icon the one or more icons.

79. A data stream according to claim 74,
wherein one or more ATSC Link-layer Protocol packets of the plurality of ATSC Link-layer Protocol packets comprise one or more fragments of a Logo/Icon Table data set,
wherein the one or more fragments of the Logo/Icon Table data set indicate information on a plurality of logos and/or a plurality of icons, wherein the plurality of logos comprises the one or more logos and/or the plurality of icons comprises the one or more icons.

80. A data stream according to claim 79,
wherein the information on the plurality of logos and/or the plurality of icons comprises information on one or more variants of each of the plurality of logos and/or of the plurality of icons.

81. A data stream according to claim 80,
wherein the Logo/Icon Table data set comprises information on two or more variants of at least one of the plurality of logos and/or of the plurality of icons.

82. A data stream according to claim 80,
wherein the information on each variant of the one or more variants of the plurality of logos and/or of the plurality of icons comprises an identifier of said variant and furthermore comprises an identifier of a physical layer pipe and/or an identifier of an ATSC Link-layer Protocol packet, which are associated with said variant.

83. A data stream according to claim 80,
wherein one or more further ATSC Link-layer Protocol packets of the plurality of ATSC Link-layer Protocol packets comprise one or more fragments of a Logo/Icon Variant data set, being a variant of one of the plurality of logos or of one of the plurality of icons,
wherein the one or more fragments of the Logo/Icon Variant data set comprise image data of said variant.

84. A data stream according to claim 82,
wherein one or more further ATSC Link-layer Protocol packets of the plurality of ATSC Link-layer Protocol packets comprise one or more fragments of a Logo/Icon Variant data set, being a variant of one of the plurality of logos or of one of the plurality of icons,
wherein the one or more fragments of the Logo/Icon Variant data set comprise image data of said variant,
wherein the ATSC Link-layer Protocol packet, which is associated with said variant, comprises the Logo/Icon Variant data set, and
wherein the physical layer pipe being identified by the identifier of the physical layer pipe, which is associated with said variant, comprises said ATSC Link-layer Protocol packet.

85. A data stream according to claim 83,
wherein at least one of the Logo/Icon Variant data set and the Logo/Icon Table data set comprises image type information indicating metadata depending on a characteristic of said variant.

86. A data stream according to claim 85,
wherein the metadata depends on an encoding of said variant.

87. A data stream according to claim 85,
wherein the metadata for said variant comprises image type information indicating whether the image data of said variant is a bitmap graphic or whether the image data of said variant is a vector graphic.

88. A data stream according to claim 87,
wherein, if the image type information indicates that the image data of said variant is a bitmap graphic, at least one of the Logo/Icon Variant data set and the Logo/Icon Table data set comprises a pixel width and a pixel height of a bitmap image being encoded within the image data of the variant.

89. A data stream according to claim 87,
wherein, if the image type information indicates that the image data of said variant is a vector graphic, at least one of the Logo/Icon Variant data set and the Logo/Icon Table data set comprises a minimum recommended number of a screen pixel width and/or comprises a minimum recommended number of a screen pixel height to render said variant.

90. A data stream according to claim 87,
wherein, if the image type information indicates that the image data of said variant is a vector graphic, at least one of the Logo/Icon Variant data set and the Logo/Icon Table data set comprises information on a ratio between a shorter side of the vector graphic to a longer side of the vector graphic.

91. A data stream according to claim 90,
wherein the decoding unit is configured to use the information on the ratio between the shorter side and the longer side of said variant to select a variant from one or more variants of one of the plurality of logos and/or of one of the plurality of icons.

92. A data stream according to claim 90,
wherein the Logo/Icon Table data set comprises information on a ratio between a shorter side of the vector graphic to a longer side of the vector graphic by indicating a number value for the shorter side, which defines the ratio between the shorter side and the longer side by assuming that a predefined reference value is assigned to the longer side.

93. A data stream according to claim 92,
wherein the number value for the shorter side is a first positive integer value, and
wherein the predefined reference value is a second positive integer value.

94. A data stream according to claim 87,
wherein, if the image type information indicates that the image data of said variant is a vector graphic, the image data is represented as an SVG vector graphic.

95. A data stream according to claim 94,
wherein, if the image type information indicates that the image data of said variant is a vector graphic, the SVG vector graphic is compressed.

96. A data stream according to claim 95,
wherein, if the image type information indicates that the image data of said variant is a vector graphic, the SVG vector graphic is compressed with deflate compression.

97. A data stream according to claim 96,
wherein the packet payload of at least one of the plurality of ATSC Link-layer Protocol packets comprises compressed other content being compressed with deflate compression.

98. A data stream according to claim 97,
wherein, if the metadata of said variant indicates that the image data of set variant is compressed, the image data of said variant is compressed with a compression algorithm supported by Journaline for image data compression.

99. A data stream according to claim 98,
wherein the compression algorithm supported by Journaline for image data compression is a deflate compression algorithm.

100. A data stream according to claim 74,
wherein one or more further ATSC Link-layer Protocol packets of the plurality of ATSC Link-layer Protocol packets comprise one or more fragments of a Link Mapping Table for services,
wherein the one or more fragments of the Link Mapping Table for services indicate one or more services of an ATSC transmission,
wherein at least one of the one or more fragments associates a logo of the one or more logos or an icon of the one or more icons with a service of the one or more services by indicating an identifier of said logo or of said icon and by associating said identifier of said logo or of said icon with said service.

101. A data stream according to claim 100,
wherein the one or more fragments of the Link Mapping Table for services are one or more fragments of a Link Mapping Table for radio services,
wherein the one or more fragments of the Link Mapping Table for radio services indicate one or more radio services of the ATSC transmission,
wherein said logo of the one or more logos or said icon of the one or more icons is associated with a radio service of the one or more radio services.

102. A data stream according to claim 101,
wherein the one or more fragments of the Link Mapping Table for radio services are one or more fragments of a Link Mapping Table for Digital Radio Mondiale-Radio,
wherein the one or more fragments of the Link Mapping Table for Digital Radio Mondiale-Radio indicate one or more Digital Radio Mondiale radio services of the ATSC transmission,
wherein said logo of the one or more logos or said icon of the one or more icons is associated with a Digital Radio Mondiale radio service of the one or more Digital Radio Mondiale radio services.

103. A data stream according to claim 74,
wherein one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission,
wherein at least one of the one or more fragments of the Link Mapping Table for Service Grouping associates a logo of the one or more logos or an icon of the one or more icons with a grouping of the one or more groupings by indicating an identifier of said logo or of said icon and by associating said identifier of said logo or of said icon with said grouping,
wherein the apparatus comprises an output interface for providing, depending on at least one of the one or more groupings, an output that depends on at least one of the plurality of services, and wherein the apparatus is configured to acquire said identifier of said logo or of said icon to output a presentation of said logo or of said icon using the output interface.

104. A data stream according to claim 103,
wherein the one or more fragments of the Link Mapping Table for Service Grouping are one or more fragments of a Link Mapping Table for Radio Service Grouping,
wherein the one or more fragments of the Link Mapping Table for Radio Service Grouping indicate one or more groupings of a plurality of radio services of the ATSC transmission,
wherein the output interface is configured to provide, depending on at least one of the one or more groupings, an output that depends on at least one of the plurality of radio services.

105. A data stream according to claim 104,
wherein the one or more fragments of the Link Mapping Table for Service Grouping are one or more fragments of a Link Mapping Table for Digital Radio Mondiale-Radio Service Grouping,
wherein the one or more fragments of the Link Mapping Table for Digital Radio Mondiale-Radio Service Grouping indicate one or more groupings of a plurality of Digital Radio Mondiale radio services of the ATSC transmission,
wherein the output interface is configured to provide, depending on at least one of the one or more groupings, an output that depends on at least one of the plurality of Digital Radio Mondiale radio services.

106. A data stream according to claim 103,
wherein the one or more fragments of the Link Mapping Table for Service Grouping associate two or more of the plurality of services with at least one of two or more categories, and/or with at least one of two or more properties,
wherein at least one of the one or more fragments of the Link Mapping Table for Service Grouping associates another logo of the one or more logos or another icon of the one or more icons with one of two or more categories, and/or with one of two or more properties by indicating an identifier of said other logo or of said other icon and by associating said other identifier of said other logo or of said other icon with said grouping.

107. A data stream according to claim 74,
wherein the one or more logos are suitable for enabling a user to conduct a service selection in a television service guide.

108. A data stream according to claim 74,
wherein the one or more icons are suitable for enabling a user to conduct a selection in a user interface or in a broadcast application.

109. A system, comprising:
an apparatus according to claim 39 for generating a plurality of ATSC Link-layer Protocol packets, and
an apparatus according to claim 1 for decoding, wherein the apparatus for decoding is configured to receive and decode the plurality of ATSC Link-layer Protocol packets.

110. A method for decoding, comprising:
receiving a plurality of ATSC Link-layer Protocol packets each of which comprising a packet header and a packet payload, wherein the packet payload of an ATSC Link-layer Protocol packet of the plurality of ATSC Link-layer Protocol packets comprises image data of one or more logos and/or of one or more icons, and
decoding the packet payload of said ATSC Link-layer Protocol packet to acquire the image data.

111. A method for generating a plurality of ATSC Link-layer Protocol packets, wherein the method comprises:
receiving image data of one or more logos and/or of one or more icons, and
generating the plurality of ATSC Link-layer Protocol packets, such that each of the plurality of ATSC Link-layer Protocol packets comprises a packet header and a packet payload,
wherein generating an ATSC Link-layer Protocol packet of the plurality of ATSC Link-layer Protocol packets is conducted, such that the packet payload of said ATSC Link-layer Protocol comprises the image data.

112. A non-transitory digital storage medium having a computer program stored thereon to perform the method for decoding, comprising:
receiving a plurality of ATSC Link-layer Protocol packets each of which comprising a packet header and a packet payload, wherein the packet payload of an ATSC Link-layer Protocol packet of the plurality of ATSC Link-layer Protocol packets comprises image data of one or more logos and/or of one or more icons, and
decoding the packet payload of said ATSC Link-layer Protocol packet to acquire the image data,
when said computer program is run by a computer.

113. A non-transitory digital storage medium having a computer program stored thereon to perform the method for generating a plurality of ATSC Link-layer Protocol packets, wherein the method comprises:
receiving image data of one or more logos and/or of one or more icons, and
generating the plurality of ATSC Link-layer Protocol packets, such that each of the plurality of ATSC Link-layer Protocol packets comprises a packet header and a packet payload,
wherein generating an ATSC Link-layer Protocol packet of the plurality of ATSC Link-layer Protocol packets is conducted, such that the packet payload of said ATSC Link-layer Protocol comprises the image data,
when said computer program is run by a computer.
